(19) United States
(12) Patent Application Publication
(10) Pub. No.: US 2021/0304197 A1
(43) Pub. Date: Sep. 30, 2021

(54) PROCESSING SYSTEM FOR PROCESSING CRYPTOCURRENCIES AND METHOD FOR PROCESSING CRYPTOCURRENCIES

(71) Applicant: SALAMANTEX GMBH, Pixendorf (AT)

(72) Inventors: Rene POMASSL, Sliema (MT); Attila ORAVECZ, Fleiligenreich (AT); Michael MUCK, Fleiligenreich (AT); Robert HUBER, Atzenbrugg (AT); Michael LOE, Traismauer (AT); Thomas HIRSCH, Fladersdorf (AT); Dominik CABRERIZO, Bad Tdlz (DE)

(21) Appl. No.: 17/265,471

(22) PCT Filed: Aug. 3, 2018
(86) PCT No.: PCT/EP2018/071114

§ 371 Date: Feb. 2, 2021

(51) Int. Cl. G06Q 20/38; G06Q 20/06

(52) U.S. Cl. CPC G06Q 20/389; G06Q 2220/00; G06Q 20/065

(57) ABSTRACT

The present disclosure provides a processing system for processing a number of cryptocurrencies, the processing system comprising a merchant terminal configured to generate transaction information as a basis for the generation of transactions with one of the cryptocurrencies, and an automatic transaction handling processor configured to process transactions generated based on the transaction information and to automatically split and/or redistribute transferred coins and/or assets based on a predetermined transfer policy. Further, the present disclosure provides a respective method.

### TECHNICAL FIELD

The disclosure relates to a processing system for processing cryptocurrencies. Further, the present disclosure relates to a respective method for processing cryptocurrencies.

### BACKGROUND

Although applicable to any type of blockchain based system, the present disclosure will mainly be described in conjunction with cryptocurrencies.

Some years ago, cryptocurrencies or crypto currencies emerged as one of the first implementations of the so called blockchain technology that lately gained large popularity.

A cryptocurrency can be seen as a system that can be used to manage digital assets, usually called “coins” of the respective cryptocurrency. The management of said coins may comprise transferring the coins, creating new coins or destroying existing coins, verifying the transfer of coins, and the like.

Cryptocurrencies use a distributed ledger, typically a blockchain, and strong cryptography to publicly process and securely document any type of action that may happen in the respective cryptocurrency system, e.g. the creation or transfer of coins, in a distributed fashion. The blockchain is a continuously growing list of records, also called blocks, that are linked to each other and secured using cryptographic functions. This means that the authenticity and the validity of a block may be cryptographically verified by anyone and that it may also be verified that a block really is the block following the preceding block and not a fake block. For example, a block may be linked to the preceding block using a hash pointer. In the block transactions of coins of the respective cryptocurrency may be documented and cryptographically signed.

Users may store their cryptocurrency coins in so called wallets. Wallets are a storage of private and public keys or addresses. A public key may be used by other users to send coins to the respective wallet. A private key in contrast allows users to write and sign transactions in the public ledger and therefore spend or transfer coins from the wallet.

Coins of a cryptocurrency may be traded between wallets of the respective cryptocurrency. Today, almost all transfers of coins of cryptocurrencies are between wallets of investors that hope for a raising value of the respective crypto currency. This means that the transfers are not performed between individuals and merchants. The value of a cryptocurrency is therefore mostly determined by investors’ expectations.

If a user wants to buy coins of a cryptocurrency e.g. with a fiat currency like euros or dollars, the user may buy the respective coins via a so called “exchange”, a company that sells coins in exchange for fiat money.

The same applies to businesses that want to accept cryptocurrencies when trading with customers. Such businesses need to prepare a wallet for the respective cryptocurrency and need to use an exchange to exchange the incoming coins for fiat money. This is a complex procedure and the business has the risk of losing the money if for example the keys to the wallet are lost or the transaction is registered in a fork of the respective blockchain.

Accordingly, there is a need for an improved cryptocurrency processing that reduces the effort for users when working with cryptocurrencies.

### SUMMARY

The above stated problem is solved by the features of the independent claims. It is understood, that independent claims of a claim category may be formed in analogy to the dependent claims of another claim category.

An automatic processing like with credit card payments in a store is not possible with cryptocurrencies, since a transaction is only sent directly from a customer's wallet to a merchant's wallet without any bank or credit card company managing the transfer of funds.

The present disclosure therefore provides a system that mitigates or reduces the complexity of processing cryptocurrencies for users. A user in this context may be any person, individual, or legal entity that is involved in processing cryptocurrencies. Users may therefore for example be a merchant, like the above-mentioned owner of the coffee shop, that sells goods and/or services and a client that consumes the sold goods and/or services.

In the following the present disclosure is mostly explained based on the simplification of the processing of cryptocurrencies for business operators. It is however understood, that the explanations also apply to the processing of cryptocurrencies between non-business individuals that may perform trades between each other. In this regard, the business or individual that receives assets of a respective cryptocurrency is called the merchant, while the individual that receives a good and/or service is called the client.

It is understood, that a wallet may refer to a pair of keys, a private key and a respective public key. The public key may also be called an address. Further, it is understood, that an address may be generated from a public key. With multi-signature wallets, the address may be generated from multiple keys or via a script. The private key, also called secret key, serves to sign transactions from the address or public key. The address or public key may also be used to look up the amount of coins and/or assets in that respective address in the blockchain. In the following the terms “wallet”, “cryptographic key”, “private key”, “public key” may therefore be used interchangeably, since they all refer to the keys that are required to access coins and/or assets in the blockchain.

The term “asset” of a cryptocurrency may refer to coins of said cryptocurrency as well as tokens, e.g. non-fungible tokens or assets, that are created based on said cryptocurrency.

To provide simplified access to a cryptocurrency and allow business to perform their business based on cryptocurrencies with ease, the present disclosure provides the merchant terminal.

The merchant terminal is a terminal that is used by the respective business to create transaction information. The transaction information will usually comprise an amount of assets, e.g. coins or non-fungible assets, to be transferred from the client to the merchant in exchange for a good and/or a service, and a respective wallet address. It is understood, that the transaction information may comprise additional information that may e.g. be presented to the client prior to confirming the transaction, e.g. details about the merchant and the acquired goods and/or services. Such information may help the client to verify the validity of the transaction information.

The merchant terminal may for example be a dedicated payment terminal. The merchant may therefore enter the respective amount, e.g. in a fiat currency like euro or dollar or the like. Entering the amount may therefore be similar to entering an amount in credit or debit card payment terminals. As alternative, the merchant terminal may be coupled to or comprise or be implemented at least in part in a POS-system (point of sale system). Such POS-system will allow a user, e.g. a store employee, to select goods and/or services and will automatically sum up the costs of the single goods and/or services to provide a final amount that is to be paid by the client.

Further, the merchant terminal may also be provided as part of or integrated into a web- or online-shop of the merchant or the like. In this case, the web- or online-shop program may generate the transaction information, e.g. based on the goods and/or the prices of the goods that a client wants to purchase in the web- or online-shop. Further, the merchant may e.g. pre-select or pre-configure any relevant settings and the web- or online-shop program may then generate the transaction information based on the pre-configured values. It is understood, that the transaction information may also be provided by a backend of the processing system, e.g. a server or a service, based on information that is provided by the web- or online-shop to the backend.

The web- or online-shop may also forward the client e.g. to a webpage that is provided by the processing system, where the client may e.g. see a list of goods and the amount to be paid and perform certain selections, like e.g. the cryptocurrency to be used for the payment and the like. This webpage may then provide the client with the transaction information required for performing the transaction, i.e. with the respective address and the amount of coins and/or assets to be transferred. It is understood, that the webpage may also provide the client with additional information, like e.g. the exchange rates for the different cryptocurrencies or the like. The client may then use the client terminal or his own wallet or a wallet built into the webpage to perform or initiate the transaction. The webpage may further provide an information to the client about the status of the transaction and redirect the client back to the merchant's web- or online-shop. The webpage may also provide information about the status and/or success or failure of the transaction to the web- or online-shop.

With the above embodiments, it is further possible to generate transaction information that may be used multiple times, e.g. for fixed price downloadable products or the like. Such transaction information may e.g. be provided in the form of payment links. The transaction information may e.g. specify the amount, like e.g. 100€, The above-mentioned payment webpage may then allow the client to input his personal details. Further, merchants may create donation links that do not specify a fixed amount. A client may then input the amount he wants to pay and any other details. Such donation links may be compared e.g. to bank transfer forms, where the bank account number of the merchant is pre-inserted.

With a dedicated payment terminal as merchant terminal, the user may simply input the final amount of a purchase, that may e.g. be provided by a separate POS-system, into the merchant terminal via an input interface. If the merchant terminal forms a unit with the POS-system the final amount will directly be available to the merchant terminal.

It is understood, that the merchant terminal may support a single cryptocurrency or various cryptocurrencies. Therefore, in the merchant terminal a specific cryptocurrency for performing the transaction may be selected, e.g. by the user of the merchant terminal or a standard cryptocurrency may be used. The merchant terminal may also retrieve the current exchange rate for the respective cryptocurrency and therefore calculate the correct amount of coins or assets in the respective cryptocurrency.

The merchant terminal will then generate transaction information that comprises the required information for transferring assets e.g. to a wallet of the operator of the merchant terminal, e.g. a shop owner. It is understood, that the transaction information may also be provided to the merchant terminal, e.g. from another element of the processing system, as will be explained below.

It is understood, that a client may provide his own terminal, e.g. in the form of a wallet application on a smartphone. Such a wallet application may also perform transactions based on cryptographic keys stored in the wallet application.

However, the client terminal may also be provided by the processing system, as well as a transaction processor. Therefore, the processing system may comprise a client terminal configured to provide a cryptographic key required for performing the transaction based on the generated transaction information, and a transaction processor configured to perform the transaction of coins and/or assets of the respective one of the cryptocurrencies as indicated by the transaction information based on the cryptographic key provided by the client terminal, wherein the automatic transaction handling processor may especially be configured to process transactions generated by the transaction processor. The method may further comprise providing a cryptographic key required for performing the transaction based on the generated transaction information on the client side, and performing the transaction of coins and/or assets of one of the cryptocurrencies as indicated by the transaction information based on the cryptographic key provided on the client side

Therefore, the processing system of the present disclosure may further provide the functions of the client terminal and the transaction processor. It is understood, that in an embodiment, the client terminal and the transaction processor may be embodied in a single entity, like e.g. in a wallet application or a hardware wallet of the respective cryptocurrency. Below different embodiments will be described, where the client terminal and the transaction processor are embodied in different entities or in a single entity.

Such a single entity may be a dedicated device, e.g. a device owned by the client. It is however understood, that the functionality of the client terminal and the transaction processor may also be provided by separate entities. Especially the function of the transaction processor may e.g. be provided at least in part in the merchant terminal. It is further understood, that the transaction processor may be implemented as any of or any combination of hardware, e.g. a processor, a microcontroller, an ASIC, a FPGA or the like, and program code, e.g. an application program, a firmware or the like.

The transaction processor is an entity that may perform the transactions as indicated by the transaction information. The term “performing transactions” with regard to any one of the entities of the processing system refers to any function necessary to initiate a transaction in the respective cryptocurrency network. Therefore “performing transactions” may for example also refer to introducing the data for the transactions into the respective cryptocurrency network. To this end the transaction processor will receive the transaction information from the merchant terminal. It is understood, that any type of data transfer is possible to provide the transaction information from the merchant terminal to the transaction processor, e.g. via an optical or a wireless data communication.

The transaction processor may then use the transaction information together with the cryptographic key provided by the client terminal to perform the necessary transaction to pay for the requested goods and/or services.

This means that the transaction processor will transfer the amount of coins or assets as indicated in the transaction information to the address indicated in the transaction information. This may e.g. happen upon a confirmation of the user after the user verifies the transaction information.

With the merchant terminal and the transaction processor that may automatically transfer the transaction information, the process of performing the transaction is already greatly simplified in contrast to the manual processing of a business deal using wallets and looking up the correct amount of coins as described above.

However, the present disclosure further provides the automatic transaction handling processor. It is understood, that the automatic transaction handling processor may be implemented e.g. on a dedicated device, like e.g. a server, or on a group of devices or e.g. in a cloud environment. The automatic transaction handling processor may therefore comprise hardware with respective computer programs or computer readable instructions that in combination perform the respective functions.

The automatic transaction handling processor is an entity that may automatically process transactions that are generated by the transaction processor. Processing transactions in the context of the automatic transaction handling processor may refer to further processing of incoming assets of the respective cryptocurrency as sent by the transaction processor in the transaction. Processing transactions in the context of the automatic transaction handling processor may also refer to an internal processing that is internal to the processing system or to a processing that involves fiat accounts at banks or the like. The automatic transaction handling processor may be provided with predetermined transfer policies and may process the incoming assets according to the provided transfer policies.

The transfer policies may for example be stored in the automatic transaction handling processor and may determine if and how incoming assets should be split and to which wallets the split assets should be transferred.

The automatic transaction handling processor therefore makes it technically possible to automatically split and retransfer assets of a cryptocurrency without intervention of the merchant or the client. Consequently, schemes that are not possible with cryptocurrencies, like e.g. percentage-based fee debiting as it is used in today's credit card systems, becomes possible for cryptocurrencies with the automatic transaction handling processor.

Unless stated otherwise, in the following description it is assumed that the transaction processor is embodied in the client terminal. It is however understood, that all explanations may also be applied to a dedicated transaction processor or to a transaction processor that is provided in the merchant terminal.

Further embodiments of the present disclosure are subject of the further dependent claims and of the following description, referring to the drawings.

In an embodiment, the merchant terminal may comprise a user interface configured to receive user input and to output respective user information, wherein the user input may refer to an amount of a fiat currency and/or to an amount of coins and/or assets of the cryptocurrency that is to be used for the transaction and/or additional information.

The user interface may e.g. be a keyboard. As alternative or in addition, the user interface may comprise a screen for outputting the user information. It is understood, that the user interface may also comprise a touchscreen as replacement of or in addition to a keyboard or single keys. On a touchscreen the elements of the user interface may be drawn on the screen that at the same time provides the user information.

It is understood, that the user interface may also be split into different parts, especially a part that may be provided in a POS-system and a part that may be provided in the merchant terminal, in case of separate units. The POS-system may e.g. be used to calculate a total sum for a purchase. This information may then be input into the merchant terminal by a user. In this case the user input comprises the amount of the respective fiat currency.

In case that the merchant terminal does not comprise any POS functionality, the user interface may e.g. comprise a character-based or alphanumeric LCD-display, e.g. comprising sever lines of characters, together with single keys or a keyboard. The user interface may also comprise a graphics display with keys or a keyboard, or a touchscreen.

If the merchant terminal and the POS-system form an integrated unit, the user input may refer to the goods and/or services that a client may request. The amount will therefore be indirectly input by the user via the selected goods and/or services. In such a case, the user interface may comprise a display and a keyboard or keys. With the POS-functionality, the display section of the user interface may especially be a color graphics display and the input section of the user interface may be a keyboard showing the single products and function keys or may be integrated with the color graphics display as touchscreen.

Prior to generating the transaction information, a user may also select the respective cryptocurrency via the user interface or provide further additional information, like e.g. a tracking code or a special user group code or the like. The tracking code may e.g. be coupled to a refund system and serves for tracking the activity of the users. The refund may be provided as an incentive for the users to participate in the tracking system. The special user group code may activate certain changes in the transfer policy or the like.

It is understood, that the additional information may be marked in the transaction information as such additional information. The additional information may especially be provided in the transaction information in a way that does not conflict with standard formats used for transferring transaction information in the respective cryptocurrency system. This will allow a client to use any wallet of his choice for performing the transaction. If, however, the client chooses to use a wallet application that accepts the additional information, the respective actions may be performed by the wallet application, like e.g. registering with the tracking service or the like.

It is however also possible that the additional information is provided such that it is inserted in fields of a transaction that may be used for arbitrary information. It is for example known that Bitcoin transaction may be used to transport arbitrary data. Other cryptocurrencies may provide dedicated fields in the transactions. If such data is provided in the transaction, the automatic transaction handling processor may also process the data and act respectively.

In a further embodiment, the merchant terminal may comprise a merchant terminal controller coupled to the user interface, wherein the merchant terminal controller may be configured to generate and output the transaction information based on user input received via the user interface.

The merchant terminal controller may e.g. comprise processing device like a microcontroller, a CPU, an integrated circuit with a controller, an ASIC, a CPLD, a FPGA or the like or any combination of the above. Further, the merchant terminal controller may also comprise a firmware and/or computer readable instructions and/or computer programs that are executed by the processing device. It is also possible that the functions of the merchant terminal controller are implemented as computer program that is executed by an operating system that is executed on the processing device.

In an embodiment, it is possible that at least part of the functions of the merchant terminal are provided as an application or computer program that is executed e.g. on a standard hardware, like e.g. a PC, a tablet, a mobile phone or the like. In a further embodiment, at least part of the functions of the merchant terminal may also be provided as a web-based application, i.e. an application that is provided as script-code and executed in a web-browser on the hardware that is provided for the merchant terminal.

It is understood, that at least some of the functions of the merchant terminal or supporting functions for the merchant terminal may also be provided on a remote server or in a backend of the processing system.

The hardware of the merchant terminal controller serves for managing the merchant terminal and therefore e.g. for providing the user output to the user, for receiving the user input from the user. The merchant terminal controller may e.g. be coupled to a display controller of the user interface for providing user output via a display of the user interface. The merchant terminal controller may also be coupled to discrete input keys, a keyboard controller or a touchscreen controller or the like of the user interface, for receiving the user input.

Generating the transaction information may comprise packing the amount and the respective wallet address in a data packet that may be processed by the client terminal. It is understood, that a known address, as e.g. defined by the merchant or an operator of the processing system may be used as the merchant wallet's address. As alternative, a new address may be generated for every transaction. As will be described below, it is possible to have a single wallet for a cryptocurrency and generate multiple addresses for said wallet, e.g. one address for every transaction.

Such a data packet with transaction information may comprise a standardized format that may e.g. be readable by all wallet applications that conform to said standardized format. The transaction information may therefore be flexibly used with any conforming wallet on the client side.

The merchant terminal controller may be configured to generate the transaction information for a predetermined cryptocurrency. This cryptocurrency may e.g. be configured by the operator of the processing system. If wanted by the operator, the merchant terminal controller may be limited to a single cryptocurrency or a predetermined group of cryptocurrencies.

This allows for example providing business sector specific merchant terminals. Such terminals may e.g. be provided with specific functionality that may only be required in a certain business sector.

In addition, or as alternative, it may also be possible for a user of the merchant terminal to select a specific cryptocurrency for the transaction manually.

In another embodiment, the merchant terminal may comprise a first communication interface that may be coupled to the merchant terminal controller. The merchant terminal controller may be especially configured to retrieve the status of the transaction via the first communication interface and provide respective user output.

The first communication interface may be any type of first data communication interface, like e.g. an Ethernet interface, a WIFI interface, a Bluetooth interface or the like. With the first communication interface the merchant terminal controller may communicate with any communication partner that is required to fulfill the respective tasks in the processing system.

The merchant terminal controller may especially communicate with the network of the respective cryptocurrency or with a respective entity in the processing system, as will be described below. that is used for the transaction to verify the status of the transaction. The status of the transaction may indicate that the transaction is pending, i.e. not yet included in a block of the respective blockchain, or for example that the transaction is performed, i.e. included in a block of the respective blockchain. It is understood, that the information about the status of the transaction may also be provided e.g. by a dedicated service provider as will be explained in more detail below. The merchant terminal controller may therefore also request the status information for the transaction via the communication terminal from the service provider.

Further, updates of the merchant terminal, i.e. the software components of the merchant terminal, may also be retrieved via the first communication interface, e.g. from a respective update server that may be provided by the operator of the processing system.

In a further embodiment, the merchant terminal controller may be configured to automatically retrieve exchange information regarding the exchange rate of the cryptocurrency that is to be used for the transaction with regard to a reference fiat currency or a different cryptocurrency and/or to retrieve transaction fee information regarding transaction fees or coin transfer fees for the transaction. It is understood, that the transaction fees may include fees that incur in the cryptocurrency network as well as fees that incur for using the processing system.

With the processing system of the present disclosure, the operator of the merchant terminal may accept cryptocurrency payments in his business. However, cryptocurrencies at present are rather volatile and may therefore quickly change their value with respect to fiat currencies or other cryptocurrencies. Therefore, providing static exchange rates in the merchant terminal may either not be accepted by a user (if the cryptocurrency has a higher value than stored in the merchant terminal) or by the operator of the merchant terminal (if the cryptocurrency has a lower value than stored in the merchant terminal).

Therefore, the merchant terminal controller may be capable of automatically retrieving exchange rates as well as transaction fees that may incur for a specific transaction. It is understood, that the merchant terminal controller may directly query exchanges for the exchange rates and the transaction fees. However, the processing system may also provide a respective information service that may constantly gather the required information from exchanges and cryptocurrency networks and provide this information in a centralized fashion to the merchant terminals.

With this information at hand, the merchant terminal controller may inform the user about the details and costs of the transaction. This for example allows a client to decide whether he wants to perform a transaction or not, based on the current value of the cryptocurrency or whether he wants to receive the cryptocurrency or a fiat currency payment, as supported by the processing system. Further, at the respective point in time fees may be too high, and the user may want make a transaction later, or the exchange rate may be low and the user may want to get the payment as crypto currency and exchange it later.

In an embodiment, the merchant terminal may comprise a transaction output interface that may be coupled to the merchant terminal controller, wherein the merchant terminal controller may be configured to output the transaction information via the transaction output interface.

The transaction output interface may e.g. be a dedicated interface, especially a wireless interface. The transaction output interface may therefore e.g. comprise an NFC interface, a RFID interface, Bluetooth interface, a LiFi or any other light modulation-based interface. Via such a transaction output interface the transaction information may be directly transmitted to the client terminal in a point-to-point communication. Via such interfaces the raw transaction data may be transmitted from the merchant terminal directly to the client terminal.

In an embodiment, the transaction output interface may be integrated into the first communication interface. This means that the merchant terminal may communicate with the client terminal via a network, like e.g. the internet to provide the transaction information to the client terminal. It is understood, that e.g. a server of the processing system may be provided to establish the communication between the merchant terminal and the client terminal. This may be especially useful if one or both of the devices are provided behind a NAT router. The server may in these cases provide NAT traversal functions and support functions for establishing the respective connection.

In an embodiment, the transaction output interface may be a WLAN interface that provides a direct connection between the merchant terminal and the client terminal. In another embodiment, the WLAN interface may e.g. be configured as a WLAN or WIFI access point to which the client terminal may connect. In this case the merchant terminal, e.g. the merchant terminal controller, may provide a server from which the client terminal may retrieve the transaction information. As alternative, the merchant terminal may provide network or internet access to the client terminal, like e.g. a wireless router. The transaction information may then be transmitted as described above.

To simplify the coupling between the client terminal and the merchant terminal, the transaction output interface may provide a WIFI network with a predetermined name or SSID. The client terminal may then automatically or after acceptance by the user connect to such a WIFI network. On the side of the client terminal, an application may e.g. be provided that only tries to connect to a WIFI with the respective name when transaction information is actively requested by the user. The same applies to other wireless communication technologies, like e.g. Bluetooth or the like, where predefined identification data may be provided for simple connection of the client terminal to the merchant terminal.

The transaction output interface may in an embodiment also be integrated into a display of the user interface. The transaction information may in such an embodiment be provided as a code, like e.g. a QR-Code, a Barcode or any other visual code that may be decoded by the client terminal, e.g. via a camera or a dedicated sensor.

In another embodiment, the transaction information may comprise a wallet address of a wallet of the operator of the merchant terminal for a cryptocurrency that is used for the transaction and to which the automatic transaction handling processor has access and/or wherein the transaction information comprises an amount of coins or of assets in said cryptocurrency.

As explained above, the transaction information may comprise a wallet address. The wallet address should be the address of/in a wallet that is under control of the operator of the merchant terminal, such that the operator may retrieve the transferred cryptocurrency. As also explained above, the automatic transaction handling processor automatically processes the transactions as they arrive at the destination wallet. Therefore, the automatic transaction handling processor should also have access to the respective wallet. As will be explained below, this may e.g. be achieved by using so called multi-signature wallets.

As further required information the amount of coins or assets of the respective cryptographic currency may also be provided in the transaction information.

In a further embodiment, the client terminal may comprise a memory, the memory storing at least a secret key for a client wallet of the cryptocurrency that is to be used for the transaction.

The client terminal may comprise any type of memory that is capable of storing a cryptographic key that is required for performing the transaction as indicated by the transaction information. Such a memory may be an electronic memory element, like e.g. an EEPROM, a flash memory, a USB memory, a hard disk or the like. It is understood, that the memory may also be an analog memory, like e.g. a piece of paper with a respective code embedded on the paper.

In cryptocurrency systems the secret key is required to transfer coins or assets from a wallet to another, i.e. to perform a transaction. Therefore, in the simplest form the client terminal may be a simple storage that only provides the required key. In other embodiments, the client terminal may however possess the required processing power to perform the transaction by itself. As indicated above for the term “performing transactions may refer to any function necessary to initiate a transaction in the respective cryptocurrency network. Therefore “performing transactions” may for example also refer to creating transaction data and/or signing transaction data and/or introducing the data for the transactions into the respective cryptocurrency network.

In case that the client terminal is a simple memory or storage for the secret key, the user may provide his consent of approval for a transaction for example simply by providing the memory, e.g. a smartcard or USB stick, such that the merchant terminal may extract the respective cryptographic key(s). In case of more complex client terminals, the user's consent may be requested via a user interface, as will be explained below. It is also possible that the cryptographic keys are provided without any explicit user consent.

In an embodiment, the client terminal may comprise a memory token with a token communication interface.

The memory token may e.g. be a card in the format of a credit card or a key fob or the like. The token communication interface may e.g. comprise a contact-based interface like e.g. used on SIM cards. As alternative the token communication interface may e.g. comprise a wireless interface, like a RFID or NFC interface.

A memory token, like e.g. a memory card, or an NFC or RFID token, may store a specific amount of data. Therefore, such a token may be used to store the cryptographic key(s) of the client's wallets that he wants to use for transactions. It is understood, that such a memory token may store the cryptographic keys of a single address and/or wallet or cryptocurrency or for multiple addresses and/or wallets or cryptocurrencies.

If cryptographic keys for multiple cryptocurrencies or wallets are stored on the memory token, a predetermined naming scheme may be used to differentiate the single keys. For example, standardized names or abbreviations for the single cryptocurrencies may be used. Since exchanges for cryptocurrencies usually use abbreviations for cryptocurrencies, like e.g. BTC for Bitcoin, such abbreviations may be used to name the data on the memory token.

If a memory token like the above mentioned is used, the merchant terminal may be equipped with or comprise the respective interface for reading the information stored on the memory token. Such an interface may be a wired card interface or a wireless RFID or NFC interface or the like. It is understood, that the above communication systems are just exemplarily mentioned and that other wired and wireless systems may also be used, like e.g. Bluetooth or the like.

If a user provides his client terminal, e.g. in the form of an NFC card, to the merchant terminal, the merchant terminal may read the cryptographic key from the memory token. The transaction processor will in this case be provided in the merchant terminal and perform the transaction with the cryptographic keys from the memory token. The merchant terminal may e.g. comprise a user input for activating the respective interface, e.g. a wired card interface or a RFID or NFC interface. The respective interface may also be set to a listen mode and automatically detect the presence of a respective memory token.

In the memory token a public key and a private key may be stored for every wallet or every address of a wallet. With the private key the merchant terminal may perform a transaction out of the client's wallet, e.g. to the merchant's wallet. With the public key the merchant terminal may perform transaction into the client's wallet.

The merchant terminal may verify the cryptographic keys prior to performing the transaction. The merchant terminal may for example verify if the cryptographic keys pertain to the selected cryptocurrency and if the respective wallet or address comprises at least the required amount of cryptographic coins or assets.

In another embodiment, the client terminal may comprise the transaction processor, and the transaction processor may be coupled to the memory, which may be provided as electronic memory. The transaction processor may be configured to perform the transaction as indicated by the transaction information based on the cryptographic key stored in the memory.

As indicated above, many types of memory may be provided for storing the cryptographic keys for the wallets of the client. Including the transaction processor in the client terminal gives the client terminal additional capabilities. The client terminal may then alone perform the transaction in the network of the respective cryptocurrency. To this end, all, in any case at least some, of the explanations given with respect to the transaction processor may also be applied to the transaction processor when included in the client terminal.

Coupling (directly or indirectly) the electronic memory to the transaction processor, allows the transaction processor to directly access the memory and retrieve the cryptographic keys that are required to perform the transaction from the memory. It is therefore not necessary to reveal the cryptographic keys to other entities.

The transaction processor may therefore perform all operations that are necessary to perform the transaction, like e.g. cryptographic signing and encryption functions, hashing functions, and the like.

If the transaction processor is not provided in the client terminal, the act of performing the transaction may be performed separate from the client terminal. In this case, client terminal provides the cryptographic key to the transaction processor, e.g. in the merchant terminal.

In a further embodiment, the client terminal may comprise a smart token, especially a smartcard, that comprises the transaction processor.

A smart token or smartcard is a device that not only comprises a memory, like the above mentioned wired or wireless memory tokens. Instead, a smart token or smartcard comprises a processor that is capable of performing at least part of the cryptographic functions required to perform the transaction.

Such a smart token or smartcard may for example be capable of negotiating a secure channel with the merchant terminal for exchanging the cryptographic keys that are required by the merchant terminal for performing the transaction.

A more advanced smart token or smartcard may also be capable of performing at least a signing function for signing the transaction. The preparation of the transaction data and the data transmission into the network of the respective cryptocurrency may then e.g. be performed by the merchant terminal.

In case that the merchant terminal communicates with the smart token to perform the transaction, the merchant terminal may e.g. require the owner of the client terminal to provide a pin code or another credential that is required to access the smart token.

In another embodiment, the client terminal may comprise a computing device and an application that is executed by the computing device and performs at least the functions of the transaction processor.

In this embodiment, the client terminal may e.g. be provided as an application on a device of the owner of the client terminal, e.g. the customer. The computing device may e.g. be a smartphone, a tablet PC, a laptop, a smartwatch or the like, that is capable of executing the application that implements the function of the client terminal. With such a computing device, the client terminal usually has access to large processing resources, first communication interfaces, a camera, a display and the like.

With such a computing device additional information may e.g. be provided to the user prior to providing the cryptographic key for performing the transaction. The user may then e.g. verify the amount of coins or assets and the address of the recipient prior to approving the transaction.

As stated above, the transaction processor may be included in the client terminal, in this case in the application. The application may therefore be able to perform transactions in the network of the respective cryptocurrency. A possible application may e.g. be a wallet application for the respective cryptocurrency. It also possible that the operator of the processing system provides a dedicated application that may e.g. comprise additional functions, e.g. to improve the efficiency of the transaction processing in the processing system.

In an embodiment, the client terminal may comprise a transaction input interface configured to receive transaction information, especially from the transaction output interface of the merchant terminal.

The transaction input interface may be an interface corresponding to the transaction output interface of the merchant terminal. If the transaction output interface for example comprises a RFID or NFC interface, the transaction input interface may also be a RFID or NFC interface. If the transaction output interface is a visual interface, like e.g. a display for displaying visual codes, like e.g. barcodes, QR codes or the like, the transaction input interface may be a camera or scanner for scanning the respective visual code. Any other interface, like a Bluetooth interface, a WIFI interface or the like may also be provided as transaction input interface.

If the merchant terminal provides wireless access, e.g. as WIFI access point, the client terminal, e.g. the transaction input interface, may be configured to automatically couple to a wireless communication partner that comprises specific properties, like e.g. a specific SSID in case of a WIFI access point, or a respective device name in case of a Bluetooth device.

It is understood, that the transaction input interface may also comprise or be embodied in the token communication interface.

In another embodiment, the client terminal may comprise a user interface configured at least to receive a user input regarding a user's consent for performing a transaction.

It is understood, that the client terminal may be configured such that the cryptographic key(s) that are required for a transaction is/are only provided after consent of the user is received.

The user interface may comprise any kind of input device that a user may use to provide his consent or approval for a transaction. Such an interface may comprise any number and any combination of e.g. keys, keyboards, touchscreens, biometrical sensors like e.g. a camera, a fingerprint sensor, or a voice recognition function, and the like.

It is understood, that the client terminal may—especially in case that a screen is provided with the user interface—provide the user with detailed information prior to asking for the user's consent for a transaction. Such detailed information may comprise the amount of coins or assets to be transferred, the address of the recipient's wallet, and any other relevant information. It may also be possible for the user to define which information he wants to be shown prior to giving his consent. Such information may e.g. be stored in the client terminal.

The user consent may be requested in many suitable forms. The user may for example simply be required to provide the client terminal, e.g. in form of a memory card, to the merchant terminal. The user may also be required to press a key or input a pin or password or the like to provide his consent. A successful fingerprint scan, iris scan, voice recognition or the like may also serve as user's consent.

In case that the client terminal has no dedicated user interface this also means that the user interface may be indirectly provided for the client terminal, e.g. by the merchant terminal that asks the user for a PIN code or the like and forwards the user input to the client terminal, e.g. in the form of a smart token or smartcard.

In a further embodiment, the user interface may be configured to receive a transaction information input from a user, the transaction information input comprising at least part of the transaction information.

If for example the user terminal comprises the transaction processor but has no communication capabilities for communicating with the merchant terminal, the user may input the transaction information by hand and perform the transaction manually. This will allow using client terminals with limited capabilities to perform transactions on the client side, i.e. without the need to disclose or reveal the cryptographic keys required for the transaction.

The user may e.g. input which cryptocurrency should be used for the transaction, the address of the wallet to which the coins or assets should be transferred, the amount of assets or coins that should be transferred and the like.

In another embodiment, the client terminal may comprise a smart token, especially a smartcard, with the user interface integrated into the smart token.

The smart token or smartcard may e.g. comprise a display, especially an electronic ink display or the like. It is understood, that the display may be a display with a low power consumption that does not change its contents if the power supply is interrupted. Further, input keys may be provided on the smart token or smartcard. Such a smartcard may therefore comprise a processing unit coupled to a memory device and a wireless token communication interface.

With such a smartcard, the user may select e.g. which cryptocurrency should be used for the transaction, and therefore which cryptographic keys should be provided by the client terminal, directly on the smart token or smartcard.

It is understood, that the power supply may e.g. be provided via the token communication interface, e.g. via a RFID or NFC system.

In an embodiment, the client terminal may comprise a setting memory configured to store user settings, and the client terminal may be configured to provide at least some of the stored user settings to the merchant terminal.

The user settings may e.g. comprise selections of the user, e.g. the owner of the client terminal, regarding his preferences, e.g. regarding his preferred cryptocurrency. The user may e.g. set a list of preferred cryptocurrencies or a single preferred cryptocurrency in the setting memory. The list may e.g. comprise the most preferred cryptocurrency of the user in the first place and the least preferred cryptocurrency of the user in the last place.

The merchant terminal may then use this list to select a cryptocurrency for the transaction. It is also possible that a list of preferred cryptocurrencies is provided by the operator of the merchant terminal in the merchant terminal. The merchant terminal may then automatically determine any matches between the preferred cryptocurrencies of the client terminal owner and the operator of the merchant terminal.

If for example the same cryptocurrency is selected by the owner of the client terminal and the operator of the merchant terminal, this cryptocurrency may be proposed or automatically used by the merchant terminal to create the transaction information. If different matches of preferred cryptocurrencies are found between the cryptocurrencies selected by the owner of the client terminal and the operator of the merchant terminal, the matching cryptocurrencies may be proposed by the merchant terminal for performing the transaction. The owner of the client terminal or the operator of the merchant terminal may then select the respective cryptocurrency.

In another embodiment, the setting memory may be configured to store automatic transaction user settings, and the client terminal may be configured to provide the automatic transaction user settings to the merchant terminal and/or to verify if requirements defined by the automatic transaction user settings are fulfilled by the transaction.

The automatic transaction user settings may define requirements that a user may set for allowing automatic transactions.

For example, a user may set a maximum amount of coins or assets for one or more cryptocurrencies that he consents to be automatically transferred in a transaction.

The user may also set a maximum number of transactions for a predetermined amount of time. This setting therefore defines how many transactions may automatically be performed in the respective amount of time.

The user may also define, with which cryptocurrency or cryptocurrency automatic transactions may be performed at all.

It is understood, that the user may set any combination of the above automatic transaction user settings.

A user may for example define that transactions in Bitcoins may be automatically be performed. The user may also limit automatic transactions e.g. to a predetermined amount of Satoshi or Bitcoins, for example 60000 Satoshi or 0,00060000 BTC (about 3,3 € at the time of writing of this document). Further, the user may limit automatic transaction to a specific number, e.g. 10 transactions per hour.

With this automatic transaction user settings, the payment process may be significantly simplified, especially for cheap goods, like e.g. a coffee, chewing gum, or in general small goods that may e.g. quickly be acquired by a client or customer e.g. directly at the checkout or at a kiosk.

The operator of the merchant terminal may e.g. input the price of the goods, e.g. 1,99 €. The client terminal may then automatically transfer, e.g. via the token communication interface or another communication interface of the client terminal the automatic transaction user settings to the merchant terminal. If the transaction fulfils the requirements defined by the automatic transaction user settings the merchant terminal may continue to perform the transaction. In case that the client terminal only comprises the memory, the merchant terminal may directly request the respective cryptographic key and perform the transaction.

In case that the client terminal comprises additional features, like the above mentioned smart tokens or the application running on a computing device, the client terminal may request the transaction information from the merchant terminal and verify if the transaction fulfills the requirements of the automatic transaction user settings. The client terminal may then automatically provide the cryptographic key to the merchant terminal which may perform the transaction. The client terminal may also perform the transaction by itself.

Automatically providing the cryptographic key or performing the transaction refers to perform the respective action without further user interaction.

Therefore, small goods may be quickly bought and paid via the processing system.

In a further embodiment, the transaction processor may comprise a cryptographic processor configured to perform cryptographic functions.

The cryptographic processor may comprise a hardware unit that may perform specific processing tasks. Such a hardware unit may e.g. comprise a processor or CPU, a microcontroller, an ASIC, a FPGA, a CPLD or the like. The cryptographic functions may e.g. comprise hashing functions, digital signature functions, encryption functions, decryption functions and the like.

With the cryptographic processor the heavy workload that is caused by the execution of cryptographic functions may be offloaded onto a dedicated device, i.e. the cryptographic processor.

It is understood, that the cryptographic processor may be a stand-alone device, e.g. in a smartcard. As alternative, the cryptographic processor may for example be integrated as co-processor or the like into the merchant terminal or the client terminal. As further alternative, the cryptographic processor may be provided as pluggable device or detachable device, like e.g. a USB stick or the like.

Further, the cryptographic processor may comprise a memory for securely storing cryptographic keys. Further, anti-tampering measures may be integrated into the cryptographic processor. Such anti-tampering measures may e.g. automatically destroy the contents of the memory when a tampering or intrusion attempt is detected.

It is understood, that the cryptographic processor may not be necessary in client terminals or merchant terminals with large processing resources, like e.g. smartphones, tablet-PCs or the like. The respective functions may in such devices be implemented as program code. However, the cryptographic processor may still be provided with such devices, e.g. for securely storing the cryptographic keys.

In an embodiment, the transfer policy may specify how new transaction are automatically generated by the automatic transaction handling processor based on the incoming transaction performed by the transaction processor.

It is understood, that a single transfer policy or multiple transfer policies may be provided for every user of the processing system, especially for the operators of the merchant terminals.

The transfer policies serve to define how the automatic transaction handling processor should automatically handle incoming transactions and redistribute incoming assets or coins. The transfer policies may e.g. define how to automatically split up incoming transactions into multiple single transactions or how to forward incoming transactions to specific wallets or addresses. This for example allows automatically transferring fees for the usage of the processing system to an address or a wallet of the operator of the processing system and transferring the remaining amount of coins and/or assets to an address or a wallet of the merchant, i.e. the operator of the merchant terminal.

Further, the transaction policies may e.g. define a day, a time of day or any other date for forwarding or splitting a transaction. Instead of a fixed date and time, a delay time may also be defined. Using a fixed time each day or a fixed interval for performing redistributing and/or splitting reduces the network load in the respective cryptocurrency network, because incoming transactions will not be handled individually but will be pooled for redistribution and splitting. Therefore, a single redistribution and/or splitting action is necessary to process a plurality of incoming transactions.

The transaction policies may in addition or as alternative also define a minimum amount of coins and/or assets that have to be available for redistributing and splitting. Further, the transaction policies may also define a minimum amount of incoming transactions that have to be received from clients prior to redistributing and/or splitting. Again, by waiting for a minimum amount of coins and/or assets or a minimum number of incoming transactions, the network load in the respective cryptocurrency network, because incoming transactions will not be handled individually but will be pooled for redistribution and splitting.

It is understood, that the merchant may anytime manually initiate redistribution and/or splitting of the coins and/or assets that are received from his clients. To this end, the processing system may e.g. provide a management interface to the merchant.

The transfer policies and the automatic transaction handling processor therefore allow an efficient and automatic handling of transactions without manual intervention.

Transfer policies may e.g. be invoked in the automatic transaction handling processor based on an identification of the respective user or merchant terminal, e.g. based on a destination address for the transaction, or based on an identification of the respective merchant terminal, that may e.g. be provided with the transaction.

Since the transfer policies may be provided individually for every user, the transfer policies with the automatic transaction handling processor therefore make it possible to perform individual and automatically processing of incoming transactions based on a user identification.

A transfer policy may for example define that incoming transactions are redistributed to one or more other addresses. In case that an incoming transaction is redistributed to more than one address, a splitting factor may be defined, wherein a high splitting factor may define that a higher amount is taken from the original transaction and that said amount is redistributed to an address that is not under control of the operator of the respective merchant terminal. Therefore, a low splitting factor may define that a low amount is taken from the original transaction and that said amount is redistributed to an address that is not under control of the operator of the respective merchant terminal. Further, the merchant or operator of the merchant terminal may further choose to split the incoming transactions.

In an embodiment, a specific transfer policy may be provided for each of multiple merchant terminals, especially for multiple terminals operated by the same operator.

Transfer policies may be provided individually for different merchant terminals that are operated by the same operator, i.e. the same merchant. It may for example be known where, e.g. in which store, the single merchant terminals are operated.

This allows to provide location-based transfer policies, which may define different rules for processing the transactions based on the location of the respective merchant terminal.

It is therefore for example possible to automatically redistribute incoming transaction to different destination addresses based on the location of the respective merchant terminal.

An operator of multiple merchant terminals may for example be a multi-national company that has stores in many countries or states. The incoming transactions may therefore be redistributed to different addresses based on the country or state of deployment of the respective merchant terminal.

In an embodiment, in each case a specific transfer policy may be provided for different times or time ranges.

The transfer policies may therefore be based on the time of day at which the transaction is initiated. This for example allows delaying transactions during times with a high volume of transactions. Further, the splitting factor may e.g. be higher during times where many transactions are performed.

In another embodiment, the transfer policy may comprise a policy based on tracking information of the user of the client terminal and/or of the operator of the merchant terminal and/or of the merchant terminal.

In another embodiment, a standard transfer policy may be used for the transaction if no specific transfer policies apply to the transaction.

The standard transfer policy may be a policy that may be used by the automatic transaction handling processor whenever no other policy applies to a transaction. Therefore, the standard transfer policy may also be seen as a fall back policy.

It is understood, that the above descriptions of the transfer policies may be applied in any combination and that specific transfer policies may be provided for every cryptocurrency that may be processed by the processing system individually.

In an embodiment, the transfer policy may indicate a target currency, e.g. another cryptocurrency or a fiat currency, for the redistribution and/or splitting of the incoming transaction.

In a further embodiment, the transfer policy may be provided at least in part by the merchant terminal and/or the client terminal.

Some of the details of the transfer policy may for example be configured by the operator of the merchant terminal and/or the operator of the client terminal per transaction, i.e. specifically fora transaction. To this end, the merchant terminal and/or the client terminal may comprise respective user inputs, that allow providing such details.

The details may refer e.g. to a required estimate of the success of the transaction and/or to the cryptocurrency or fiat currency that the operator of the merchant terminal prefers to receive from the transaction (see below). Any other detail of the transfer policy may also be provided by the merchant terminal and/or the client terminal.

In an embodiment, the automatic transaction handling processor may comprise a transaction interface that may be configured to receive information about the transaction performed by the transaction processor or in the respective cryptocurrency network.

The transaction interface may comprise a hardware interface, like e.g. a network interface or the like. It is understood, that the transaction interface may also comprise a software interface, like e.g. a communication link to the cryptocurrency network used for the transaction, or e.g. a SOAP or REST API or the like to a service that provides the information about the transaction. The transaction input interface may therefore comprise hardware, software or a combination of both.

The information about the transaction may comprise a plurality of different information tokens. For example, the information may comprise information about the transaction being received in the respective cryptocurrency network.

However, a new transaction however is not necessarily processed and performed as soon as it is received in the respective cryptocurrency network. Therefore, the transaction may for example be processed by a so-called miner that produces a block in the blockchain of said cryptocurrency. Only when the block is created, the transaction is performed in the blockchain. Therefore, the information about the transaction may also comprise the fact that the transaction is included in a new block.

Further, in a blockchain a phenomenon called a fork may appear. Therefore, to make sure that the transaction is actually part of the longest part of the blockchain and not a fork, the information may also refer to the number of blocks being created in the blockchain after the block that comprises the transaction.

With the information about the transaction at hand, the automatic transaction handling processor may decide when to perform the redistribution and/or splitting of the transaction.

The automatic transaction handling processor may for example only accept a transaction as performed if a predefined number of new blocks is created following the block that contains the transaction without any fork. For example, 5-10, especially—9 oror 7 new blocks may be required.

However, in order to speed up the transaction processing, the automatic transaction handling processor may also process transaction immediately that are only included in a single new block.

In a further embodiment, the automatic transaction handling processor may comprise a local transaction processor that may be configured to perform transactions as indicated by the respective transfer policy.

It is understood, that the local transaction processor may e.g. be coupled to the transaction interface to perform the transactions. If for example the transaction interface comprises a network interface, the local transaction processor may use this network interface to communicate with the respective cryptocurrency network or other entities as required.

In another embodiment, the processing system may comprise a wallet generator, that may be configured to generate for the operator of the merchant terminal a system wallet and a storage wallet.

The system wallet of the operator is the wallet that is used for receiving transactions that are initiated by a user of the client terminal. The system wallet therefore may be the wallet that the automatic transaction handling processor accesses for redistributing and/or splitting the transaction.

The storage wallet may be the wallet that the operator of the merchant wallet uses to store his coins and/or assets that are forwarded to the storage wallet by the automatic transaction handling processor.

By providing two different wallets for the operator of the merchant terminal, it is possible to perform a separation of concerns. While the system wallet may be accessible by the automatic transaction handling processor, the storage wallet may for example only be accessible by the operator of the merchant terminal. Therefore, coins and/or assets in the storage wallet may not be removed without consent of the merchant. By “accessible” it is understood, that only the respective person or entity possesses the cryptographic keys required to perform transactions out of the respective wallet.

By “generating a wallet” it is understood, that the wallet generator generates the respective cryptographic keys and addresses that are required to operate the respective wallet.

In an embodiment, the system wallet may be provided as a multi-signature wallet and/or as a hierarchical deterministic wallet, and/or the storage wallet may be provided as a multi-signature wallet and/or as a hierarchical deterministic wallet.

Multi-signature wallets are wallets for which multiple cryptographic keys exist. Further, upon creation of the respective multi-signature wallet, it may be defined how many of the keys are required to perform a transaction out of the respective wallet. It is therefore for example possible to define that four cryptographic keys exist fora multi-signature wallet and that at least two of the cryptographic keys are required to perform a transaction. Or a wallet may be created with three cryptographic keys and that two keys are required for performing transactions out of the respective wallet.

In an embodiment, the system wallet may be provided with four cryptographic keys and two of the cryptographic keys may be required to perform a transaction out of the system wallet. The system wallet may therefore be called a 2-of-4 wallet.

Two of the cryptographic keys may be provided to the operator of the merchant terminal. The other two cryptographic keys may be provided to the automatic transaction handling processor. With this arrangement, the operator of the merchant terminal always has full access to the coins and/or assets in the system wallet. At the same time, the automatic transaction handling processor possess two of the cryptographic keys and may therefore automatically perform transactions for splitting and/or redistributing coins and/or assets from the system wallet.

Since the automatic transaction handling processor is under control of the operator of the processing system, the automatic transaction handling processor may automatically split transactions that income into the system wallet for example to deduce the fees that incur for using the processing system and transfer the fees onto a wallet of the operator of the processing system. The remaining coins and/or assets may then be transferred to the storage wallet of the operator of the merchant terminal.

In a further embodiment, the storage wallet may be provided with three cryptographic keys and two of the cryptographic keys may be required to perform a transaction out of the system wallet. The system wallet may therefore be called a 2-of-3 wallet.

Two of the cryptographic keys may be provided to the operator of the merchant terminal. The other cryptographic key may be provided to the automatic transaction handling processor. With this arrangement, the operator of the merchant terminal always has full access to the coins and/or assets in the storage wallet. He may therefore perform arbitrary transactions from the storage wallet. At the same time, the automatic transaction handling processor possesses only one of the cryptographic keys and may therefore not perform any transactions from the storage wallet without consent of the operator of the merchant terminal.

This consent may e.g. be required when the operator of the processing system transfers coins and/or assets from the merchant's storage wallet to a wallet in his possession in order to transfer the corresponding amount of fiat currency to a bank account of the merchant.

Hierarchical deterministic wallets allow creating multiple keys starting from a single starting key, sometimes called mnemonic if words are used. Therefore, a mnemonic may be used to create multiple wallets and/or addresses for a single user. With the knowledge of the initial starting key it is then possible to reconstruct all keys and therefore to reconstruct the complete contents of wallets, even if the keys have been lost.

For example, a single starting key may be provided for an operator of the merchant terminal. With this starting key a master private key may be generated that forms the basis for the generation of an arbitrary number of private keys and public keys, or addresses, respectively. Therefore, based on the starting key a wallet may be generated for every cryptocurrency the merchant wants to use and a single pair of keys and/or addresses may be generated for every single transaction that is performed or received by the merchant.

The starting key may for example be an arbitrary alphanumerical starting key. In an embodiment, the starting key may e.g. comprise a specific number of words and/or numbers. In this case the starting key may be called mnemonic. The advantage is that it is easier to remember a sequence of 12 words instead of e.g. a 128 Bit numerical value.

As already indicated above, the system wallet may be provided with four cryptographic keys and two of the cryptographic keys may be required to perform a transaction out of the system wallet. The system wallet may therefore be called a 2-of-4 wallet. In addition, the storage wallet may be provided with three cryptographic keys and two of the cryptographic keys may be required to perform a transaction out of the system wallet. The system wallet may therefore be called a 2-of-3 wallet.

The wallet generator may for example generate for the system wallet four cryptographic keys, two cryptographic keys which may be provided to the merchant and two cryptographic keys which may be kept in the processing system or be provided to the operator of the processing system. For the storage wallet the wallet generator may generate three keys, two cryptographic keys which may be provided to the merchant and one cryptographic key which may be kept in the processing system or be provided to the operator of the processing system.

For the system wallet, the keys provided to the operator of the processing system may be seen as two transaction keys that allow the operator of the processing system to process transactions in the system wallet automatically without requiring any interaction of the operator of the merchant wallet.

The operator of the merchant wallet, i.e. the merchant, will usually not need to access the system wallet. However, with the two keys he receives, the merchant may always access the system wallet. This may be seen as a precautionary measure to always allow the merchant to access the funds in his system wallet, for example even if the processing system is shut down.

Further, even if either the operator of the processing system or the merchant loses one of the keys, together both may still transfer the contents of the system wallet to another newly created wallet for which all keys are available.

In an embodiment, one of the merchant's keys may be used for the transaction from the merchant wallet. This key may be stored in encrypted form on a server of the processing system. The other merchant key may be a backup key. This backup key may e.g. not be stored on the server. In an example, the private key is not stored on the server, however, the public key is stored and needed for the creation of the addresses.

The operator of the processing system can store his one or two keys (depending on the wallet) in an analogous way. The keys of the operator of the processing system may also be stored in encrypted form on the server and can be stored as mnemonic in an offline secure place, or on another highly secure server. Only when the system data gets lost completely, the mnemonics would be used to recover the lost keys.

Regarding the storage wallet of the merchant, only the merchant should have full access to the contents of the storage wallet. Therefore, three keys may be generated for the storage wallet. This will allow the merchant to transfer coins and/or assets from the storage wallet whenever required. If, however, the merchant loses one of his keys, the operator of the processing system may use his key, i.e. the third key for the wallet, to allow the merchant to transfer the funds into a newly created wallet.

In an embodiment, the processing system may comprise a wallet storage, that may be configured to store for the operator of the merchant terminal a system wallet and a storage wallet, i.e. the respective public keys, i.e. addresses, and private keys.

The wallet storage may be a simple storage like a database where the respective keys may be retrieved by the processing system or the merchant when required. However, in an embodiment, the wallet storage may store the cryptographic keys in an encrypted form.

It is understood, that the cryptographic keys of the merchant may be encrypted with a single key, i.e. one key for all pairs of private key and public key of the merchant, or with multiple keys, i.e. one per pair of private key and public key, that may be chosen by the merchant. The keys of the processing system may be encrypted with a single key or multiple keys that may be provided by the processing system.

In an embodiment, the merchant may use a single or same password for all his wallets. Even if a single password is used, every private key may be encrypted separately and stored in the merchant's entry of the respective database. Also, more complex structures are possible. For example, multiple persons in a merchant's company may each have their own password for a key, so the key would be encrypted and stored multiple times in the system.

This implies, that although the cryptographic keys of the merchant are available in the wallet storage of the processing system, these cryptographic keys may only be used with the consent of the merchant. This may for example be used in case that the merchant wants to retrieve coins and/or assets as fiat currency via an exchange that is provided in or coupled to the processing system.

In this case, the processing system may ask the merchant for his key to decrypt one of the respective keys to the storage wallet that are stored in the wallet storage. The processing system may then use the one key that is provided to the processing system for the storage wallet and the decrypted key to transfer coins and/or assets to an address of the respective exchange.

In an embodiment, the merchant does not need to store any private keys on any server or service. Instead, the respective server or service would just possess the respective public keys, especially for address generation.

The merchant, in this embodiment, does not need to give his private key away. Instead, the merchant may save his private key for the respective wallet in a wallet under his possession. Such a wallet may e.g. be a “hardware wallet” comprising special hardware that has wallet features, like signing a transaction.

In the processing system, transactions are then generated by asking the merchant to connect his respective wallet, e.g. a hardware wallet, instead of asking the merchant for his password to decrypt the private key. The respective wallet gets connected to the merchant pc e.g. via a USB interface. The processing system, e.g. the automatic transaction handling processor, may send the built transaction, not signed or half signed, e.g. via the browser to the hardware wallet. The hardware wallet, may then check the transaction, optionally display the most important information, and ask the merchant for verification. The hardware wallet may then sign the transaction and send the signed transaction back to the server. The server may check the signed transaction and sends it to the cryptocurrency network.

In a further embodiment, the processing system may comprise a directive verification processor, that may comprise one private key of two private keys, to which the processing system has access, for the system wallet and that may be configured to verify if a transaction conforms to predetermined directives prior to releasing the private key for performing the transaction.

As explained above, the system wallet may be a 2-of-4 wallet. Further, the processing system, especially the automatic transaction handling processor, may have access to two of the four private keys of the respective wallet. However, one of the private keys may be protected by the directive verification processor. This means that the directive verification processor will only release the respective private key for performing a transaction if the transaction conforms to the predetermines directives.

A directive may define specific criteria that the transaction has to match in order to be accepted as valid. The criteria may for example define a recipient address, a maximum amount of coins and/or assets to be transferred, a minimum amount of time that has to be passed since the last transaction from the system wallet and the like.

The directive verification processor may be seen as an additional safety measure that only allows the processing system, especially the automatic transaction handling processor, to perform a transaction if the transaction is valid.

The directive verification processor may be provided as a dedicated component that is coupled to the automatic transaction handling processor, instead of being integrated into the automatic transaction handling processor. This reduces the risk of transferring coins and/or assets to the wrong address, if for example part of the automatic transaction handling processor is compromised or infiltrated by an attacker.

The directive verification processor may also act as an authentication system. It is for example to implement a multi-factor authentication via the directive verification processor. If for example, the merchant wants to withdraw coins and/or assets from the system wallet as fiat currency or transfer the coins and/or assets to another wallet than the merchant wallet, the automatic transaction handling processor may prepare a respective transaction. However, the directive verification processor may only provide the respective private key, if the merchant provides an authentication token to the directive verification processor. Such a token may e.g. be a pin, a tan (transaction number) or another code. A tan or code may e.g. be provided to the merchant via a separate channel, like e.g. SMS, an application on a mobile phone, a messenger message or the like.

The processing system may for example provide the merchant with a management interface, that allows him to initiate such transactions and input the pin, tan or code.

In another embodiment, the transaction may comprise a transfer of non-fungible assets.

Non-fungible assets are assets that are unique and may each be individually identified, in contrast to for example coins, which may interchangeably be used and are said to be fungible.

The non-fungible assets may for example be provided by the operator of the processing system. For example, the operator of the processing system may sell the non-fungible assets to users that may then purchase goods and/or services with the non-fungible assets.

If the operator of the processing system provides the non-fungible assets, he may also control their value. The operator may for example sell and buy 100 non-fungible assets for a fixed price, like e.g. one euro. Therefore, the price of the non-fungible assets will always be coupled to the euro.

Non-fungible assets may on the one hand be bound to a fiat currency, e.g. by an entity that guarantees to buy and sell the non-fungible assets for a fixed price, wherein transaction fees may be charged by said entity.

If non-splitable non-fungible assets are transferred, transaction fees and the like may be recorded and deduced from the next coin-based transaction, e.g. by the automatic transaction handling processor. As alternative, two new non-fungible assets may be created while the received non-fungible asset is destroyed.

Further, stolen non-fungible assets may be marked or registered as stolen, e.g. in a dedicated database or in the blockchain. It is therefore possible to identify the stolen non-fungible assets when someone tries to use them.

In a further embodiment, the merchant terminal may comprise an account information source, and the client terminal may be configured to extract account information from the account information source and instruct the transaction processor to perform a transaction based on the account information.

The account information source may be any kind of data source. Such a data source may for example comprise a digital data token, that may be read wirelessly or contact-based. Such a digital data token may e.g. be a RFID or NFC token, a memory card or the like. As alternative, the account information source may e.g. comprise a visual code that may be printed on paper or a sticker or the like. Such a visual code may e.g. be provided by the merchant near the cash register.

The account information may refer to any type of information that allows the recipient of the transaction from the client terminal to identify the merchant that owns the merchant terminal. Such account information may therefore for example comprise any one of or a combination of a wallet address, a merchant ID, an IBAN or account number of a bank account of the merchant or the like.

The client terminal may e.g. comprise a RFID or NFC interface or an optical interface or scanner to retrieve the account information. With the account information, the client terminal may then prepare a respective transaction.

If the account information comprises a recipient address, the client terminal may use this recipient address as the destination address for the transaction. If the account information comprises an ID or IBAN or bank account number of the merchant, the client terminal may include this information as additional information in the transaction.

The recipient address may for example be the address of the system wallet of the merchant. It is however also possible that in addition or as alternative the recipient address refers to a wallet under control of the operator of the processing system or an exchange. The merchant may for example register with the processing system or the exchange service and only create a single wallet.

It is understood, that the transaction processor may be provided in the client terminal and that the client terminal may perform the transaction with the integrated transaction processor.

The automatic transaction handling processor or the exchange service may then analyze the incoming transaction and for example automatically transfer the received coins and/or assets as fiat currency to a bank account of the merchant. The merchant may register the bank account number in advance with the processing system or the exchange service.

If the recipient address for example is the address of a pooling wallet, e.g. operated by the operator of the processing system or the exchange service, the merchant may e.g. be identified by the ID provided with the account information. Further, the merchant may be identified by the IBAN or account number.

The operator of the processing system or the exchange service may after identifying the merchant by an ID look up the account details of the merchant and transfer the respective amount of coins and/or assets either as crypto coins and/or assets to a respective wallet or as fiat currency to a bank account.

If the bank account number is provided, e.g. as IBAN, in the transaction details, the operator of the processing system or the exchange service may directly transfer the incoming coins and/or assets to the respective bank account.

It is understood, that in this document the single elements of the processing system are described. It is however also understood, that the present disclosure is meant to also disclose the single elements of the processing system on their own, i.e. separate from the processing system. The present disclosure therefore also discloses a merchant terminal on its own with the above and below mentioned features. Further, the present disclosure also discloses the client terminal on its own with the above and below mentioned features. In addition, the present disclosure also discloses the transaction processor on its own with the above and below mentioned features. In addition, the present disclosure also discloses the automatic transaction handling processor on its own with the above and below mentioned features. In addition, the present disclosure also discloses the exchange rate service on its own with the above and below mentioned features. In addition, the present disclosure also discloses the exchange service on its own with the above and below mentioned features. In addition, the present disclosure also discloses the exchange rate optimizer on its own with the above and below mentioned features. In addition, the present disclosure also discloses the transaction verification controller on its own with the above and below mentioned features. In addition, the present disclosure also discloses the fork detection system on its own with the above and below mentioned features. In addition, the present disclosure also discloses the wallet storage on its own with the above and below mentioned features. In addition, the present disclosure also discloses the wallet generator on its own with the above and below mentioned features. In addition, the present disclosure also discloses the directive verification processor on its own with the above and below mentioned features. In addition, the present disclosure also discloses the offline paper wallet generator on its own with the above and below mentioned features. In addition, the present disclosure also discloses the contract generator on its own with the above and below mentioned features.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a block diagram of an embodiment of a processing system according to the present disclosure;

FIG. 2 shows a block diagram of an embodiment of a merchant terminal according to the present disclosure;

FIG. 3 shows a block diagram of another embodiment of a merchant terminal according to the present disclosure;

FIG. 4 shows another block diagram of the embodiment of a merchant terminal according to the present disclosure of FIG. 3;

FIG. 5 shows another block diagram of the embodiment of a merchant terminal according to the present disclosure of FIG. 3;

FIG. 6 shows another block diagram of the embodiment of a merchant terminal according to the present disclosure of FIG. 3;

FIG. 7 shows a block diagram of another embodiment of a merchant terminal according to the present disclosure;

FIG. 8 shows a block diagram of another embodiment of a merchant terminal according to the present disclosure;

FIG. 9 shows a block diagram of an embodiment of a client terminal according to the present disclosure;

FIG. 10 shows a block diagram of another embodiment of a client terminal according to the present disclosure;

FIG. 11 shows a block diagram of another embodiment of a client terminal according to the present disclosure;

FIG. 12 shows a block diagram of another embodiment of a client terminal according to the present disclosure;

FIG. 13 shows a block diagram of another embodiment of a client terminal according to the present disclosure;

FIG. 14 shows a block diagram of another embodiment of a client terminal according to the present disclosure;

FIG. 15 shows a block diagram of another embodiment of a client terminal according to the present disclosure;

FIG. 16 shows a block diagram of an embodiment of an automatic transaction handling processor according to the present disclosure;

FIG. 17 shows a block diagram of an embodiment of an exchange rate service and an exchange service according to the present disclosure;

FIG. 18 shows a block diagram of an embodiment of an exchange rate optimizer according to the present disclosure;

FIG. 19 shows a block diagram of an embodiment of a transaction verification controller according to the present disclosure;

FIG. 20 shows a block diagram of an embodiment of a fork detection system according to the present disclosure;

FIG. 21 shows a block diagram of an embodiment of a wallet storage and a wallet generator according to the present disclosure; and

FIG. 22 shows a block diagram of an embodiment of a directive verification processor according to the present disclosure.

In the figures like reference signs denote like elements unless stated otherwise.

### DETAILED DESCRIPTION OF THE DRAWINGS

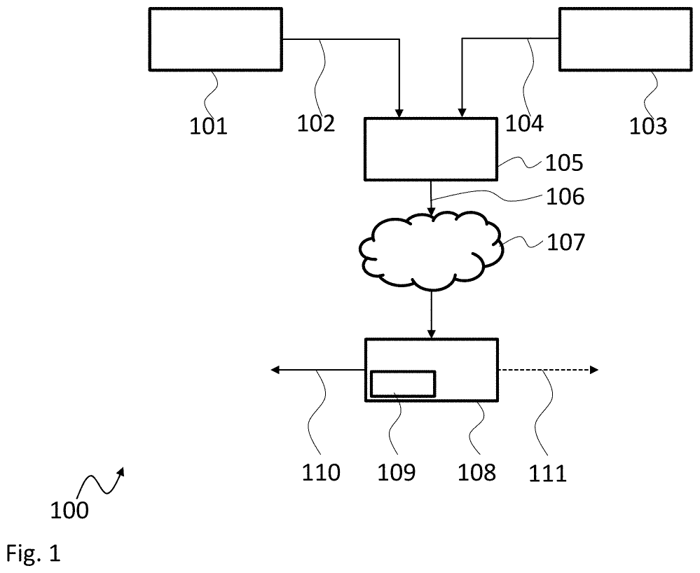

FIG. 1 shows a block diagram of a processing system 100. The processing system 100 comprises a merchant terminal 101, a client terminal 103, a transaction processor 105 that is coupled to the merchant terminal 101 and the client terminal 103, and an automatic transaction handling processor 108 that is coupled to the transaction processor 105 via a network 107, e.g. the internet 107 and comprises a predetermined transfer policy 109.

With the processing system 100 a merchant and a client or customer may use cryptocurrencies to perform trades. The merchant may for example sell the client goods and/or services.

The processing system 100 supports the settlement of such trades via cryptocurrencies. To this end, the merchant terminal 101 provides transaction information 102. The transaction information 102 may e.g. be generated based on an input by the merchant. Such an input may for example refer to an amount to be paid by the client. The amount may e.g. be provided by the merchant to the merchant terminal 101 as amount of a fiat currency or as amount of a cryptocurrency. If the amount is provided by the merchant as an amount of fiat currency, the merchant terminal may allow the merchant to select a cryptocurrency that is to be used for settling the debts of the client. The cryptocurrency to be used and the amount of coins and/or assets to be transferred may then be provided in the transaction information 102. Further, the address for the receiving wallet, also called system wallet, of the merchant may also be provided in the transaction information 102. The transaction information 102 may then be provided to the transaction processor 105. It is understood, that the merchant terminal 101 may generate the transaction information 102 autonomously. In another embodiment, the merchant terminal 101 may provide the required information, like e.g. the selected cryptocurrency and the amount to be paid, to a backend of the processing system 100, e.g. to a sever or a service hosted on a server. The backend may then provide the transaction information 102 to the merchant terminal 101 for forwarding to the transaction processor 105. The transaction information 102 generated in the backend may e.g. comprise the receiving address, the amount of coins and other details. It is further understood, that the generated transaction information 102 may e.g. be shown to the merchant for confirmation, e.g. on a user interface of the merchant terminal 101.

A wallet usually comprises one or multiple pairs of keys that in combination form a deposit for coins and/or assets of the respective cryptocurrency. A pair of keys comprises a public key, which forms the address and is publicly known. The pair of keys further comprises the private or secret key that is only known to the owner of the respective pair of keys. The private key is required to sign transactions. If the signature matches the public key, a transaction is assumed to be valid and the transfer of the respective amount of coins and/or assets from the respective address is stored in the blockchain.

The client may be in possession of one or multiple wallets. The respective cryptographic keys 104 may be stored in the client terminal 103. Therefore, to settle a debt, the client may use the client terminal 103 to provide the respective cryptographic keys 104 to the transaction processor 105.

The transaction processor 105 may then create a transaction 106 based on the transaction information 102 and the cryptographic key 104, and provide the transaction 106 to the network 107 of the respective cryptocurrency. It is understood, that the network 107 not necessarily is a dedicated network. Instead the network 107 of the cryptocurrency may e.g. be an overlay network that is formed of all nodes of the cryptocurrency network on top of another network, like e.g. the internet.

The processing system 100 further comprises the automatic transaction handling processor 108. The automatic transaction handling processor 108 allows to automatically process incoming data or transactions of all cryptocurrencies that may possibly be used with the processing system 100.

The automatic transaction handling processor 108 further processes the incoming transaction 106 generated by the transaction processor 105. Processing may refer to detecting the transaction 106 and to automatically splitting and/or redistributing transferred coins and/or assets based on the predetermined transfer policy 109, e.g. an outgoing transaction 110, and optionally further outgoing transaction 111.

The automatic transaction handling processor 108 may forward the incoming coins and/or assets to a predetermined address, e.g. in transaction 110. However, the automatic transaction handling processor 108 may also split the incoming transaction, i.e. the automatic transaction handling processor 108 may automatically process the incoming data and perform a data conversion to provide two outgoing transactions 110, 111.

In an embodiment, the transaction 110 may serve to forward coins and/or assets to a wallet of the merchant to which only the merchant has access, e.g. the merchant wallet.

The outgoing transaction 111 may serve to forward a specific part of the coins and/or assets that have been transferred in transaction 106 to another wallet, e.g. a wallet of the operator of the processing system 100.

The automatic transaction handling processor 108 in any case will split and/or redistribute the incoming coins and/or assets based on the transfer policy 109. The transfer policy 109 may also be provided at least in part by the merchant terminal 101 and/or the client terminal 103.

The transfer policy 109 specifies how new transactions 110, 111 are automatically generated by the automatic transaction handling processor 108 based on the incoming transaction 106 performed by the transaction processor 105.

The transfer policy 109 may also indicate a target currency for the redistribution and/or splitting of the incoming transaction 106. Such a target currency may be a cryptocurrency, e.g. the cryptocurrency that is used for transaction 106 or another cryptocurrency. Further, the target currency may also specify a fiat currency. Below it will be explained in detail how the automatic transaction handling processor 108 may exchange different currencies either with an integrated exchange or via an external exchange or exchange service.

The transfer policy 109 may also be based on tracking information of the user of the client terminal 103 and/or of the operator of the merchant terminal 101 and/or of the merchant terminal 101. Such information may be provided either as additional information in the transaction 106 or via a dedicated interface between the merchant terminal 101 or the client terminal 103 and the automatic transaction handling processor 108.

A specific transfer policy 109 may for example be provided for each of multiple merchant terminals 101. Multiple merchant terminals may pertain to multiple merchants. In addition, or as alternative, multiple terminals may pertain to a single merchant. Further, in each case a specific transfer policy 109 may be provided for different times or time ranges.

A standard transfer policy 109 may be used for the transaction 106, if no specific transfer policy 109 applies to the respective transaction 106.

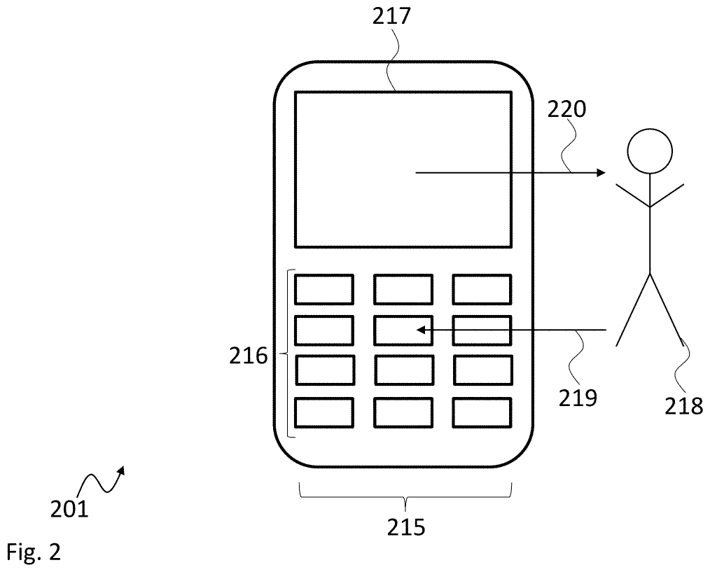

FIG. 2 shows a block diagram of a possible merchant terminal 201 in a front view. The merchant terminal 201 comprises a user interface 215. The user interface 215 comprises a keyboard 216 and a display 217.

The keyboard 216 serves for receiving user input 219 from user 218, e.g. the merchant. The display 217 serves for providing user information 220 to the user 218.

The merchant terminal 201 as shown in FIG. 2 may for example be embodied as a dedicated device. Such a device may serve exclusively as a merchant terminal as described herein. It is however understood, that the merchant terminal 201 may also be provided e.g. as an application running on a smartphone or a tablet PC or any other computer. As alternative or in addition, the merchant terminal 201 may also be provided e.g. integrated into a POS system. In such embodiments, the keyboard 216 may also be substituted by respective inputs on a touchscreen of the respective device, as will be seen below.

It is understood, that although not shown, the merchant terminal 201 may comprise additional elements, like e.g. a network interface like a WIFI or Ethernet interface, a short distance interface, like e.g. a RFID or NFC interface, a further screen, e.g. for displaying information to the client, and the like.

With the merchant terminal 201, the user 218 may for example input an amount of a fiat currency to be paid and/or select a cryptocurrency to be used for the transaction via the keyboard 216.

The display 217 may for example be used to display information to the user 218. Such information may e.g. refer to the amount to be paid, the cryptocurrency to be used for the transaction, an exchange rate between the cryptocurrency and a predetermined fiat currency, and the like.

When all required information has been provided to the merchant terminal 201 by the user 218, the user 218 may provide the respective transaction information, e.g. in the form of a visual code, like e.g. a QR code, on the display. In addition, or as alternative, the user 218 may provide the transaction information e.g. via a network interface, via a RFID or NFC interface or via a wired interface.

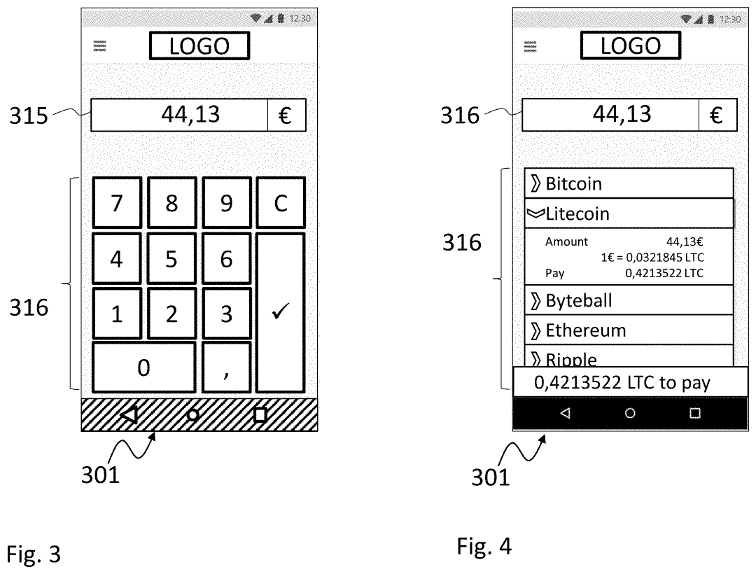

FIG. 3 shows a block diagram of another merchant terminal 301. The merchant terminal 301 is provided as a computing device with an application that is executed on the computing device. FIG. 3 focuses on the user interface, which is provided as touchscreen, and especially with a keyboard 316, and with a display 315. It is understood, that the display 315 and the keyboard 316 are provided as sections on the touchscreen.

It can be seen, that the user interface may further comprise elements, like e.g. a logo, an indication of battery power, wireless network strength (at the top), and general buttons like, back, accept, or menu (at the bottom). It is understood, that these elements may for example be provided by an operating system that is executed on the computing device.

The keyboard 316 shows numbers, which allow the user to input the price in € that is to be paid by a client. Further, an enter button “✓” and a cancel button “C” are shown. In an embodiment, the user may also tap the “€” symbol in the section of the display 315 and change to another fiat currency, like e.g. $ or the like. If the user enters an amount and accepts via the enter button “✓”, the user interface changes to the user interface shown in FIG. 4.

FIG. 4 shows another block diagram of the merchant terminal 301, with the user interface after a user enters and accepts an amount of a fiat currency to be paid. The display 315 still shows the amount to be paid in the respective fiat currency, here Euro. It is understood, that the user in some embodiments, may change the fiat currency by tapping the “€” symbol, as explained above.

In the keyboard section 316 of the user interface a list of different cryptocurrencies is shown, that are supported by the processing system for performing payments. In FIG. 4 exemplarily the following cryptocurrencies are shown: Bitcoin, Litecoin, Byteball, Ethereum, Ripple. It is understood, that this selection of cryptocurrencies is just exemplary and that any other type and number of cryptocurrencies may be shown in other embodiments.

In the example of FIG. 4 the cryptocurrency “Litecoin” is selected. Below the “Litecoin” entry, the amount to be payed is shown in Euro. Further, the exchange rate of 1 € to Litecoin is shown. Finally, the amount to be payed is shown in Litecoins, here 0,4213522 LTC.

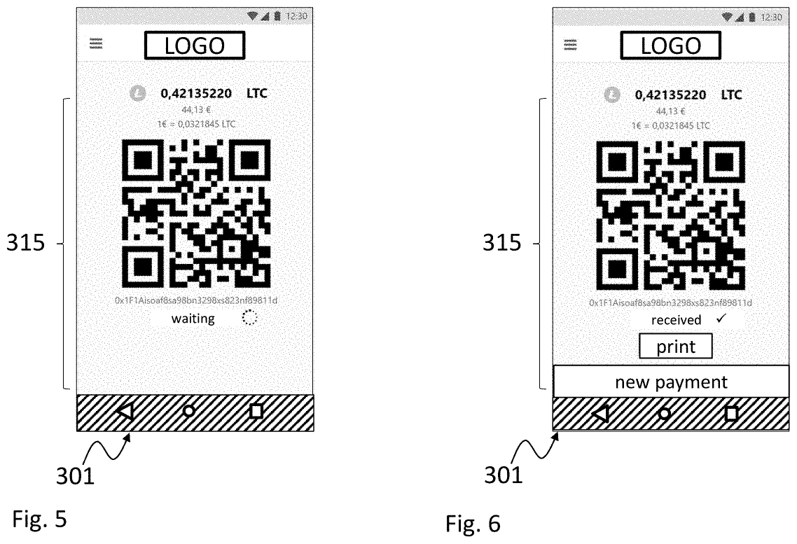

If the user selects Litecoin for payment, e.g. by double tapping the Litecoin entry, the user interface may change to the exemplary user interface shown in FIG. 5.

In FIG. 5 the user interface comprises only the display 315. The display 315 shows a QR code that comprises all information required to perform a transaction. It is understood, that the user interface as shown in FIG. 5 may e.g. be used if the client wants to perform the transaction with his own device, e.g. with a smartphone that may scan the QR code with its camera.

The QR code on the display 315 may comprise for example the wallet address of the merchant wallet to which the transaction should be destined. In addition, the QR code may also comprise the amount of respective coins and/or assets that should be transferred. It is understood, that any other additional information may be embedded in the QR code. Such information may e.g. comprise tracking information for tracking the merchant's activities or for a cashback program or the like.

In another embodiment, the merchant terminal 301 may also output the transaction information via other interfaces, e.g. via a network interface like a WIFI or Ethernet interface, via a short distance like a RFID or NFC interface, or a wired interface or the like.

The client scans the QR code or receives the QR code via another interface in his device, e.g. his smartphone. He may then verify the transaction information, e.g. on the display of the smartphone, and then perform the transaction. In this case, the transaction processor may be integrated into a wallet application running on the client's device.

While the transaction is being created and processed in the cryptocurrency network, the display 315 may shown the status as “waiting”.

FIG. 6 shows the merchant terminal 301 after the transaction is being received. The display 315 still shows the QR code. However, after the transaction is received, the status below the QR code also shows “received” and a receipt of the transaction may e.g. be printed by the user by tapping the “print” button. Blow the print button a new transaction may be initiated via the “new payment” input.

It is understood, that specific settings may be provided in the merchant terminal or a respective service of the processing system, that specify how a transaction should be validated or rated as received. If in the used cryptocurrency, i.e. in the underlaying blockchain, forks may occur, a transaction may for example only be accepted if a specific number of blocks, e.g. 3, 4, 5, 6 or 7 blocks, have been created after the block comprising the transaction.

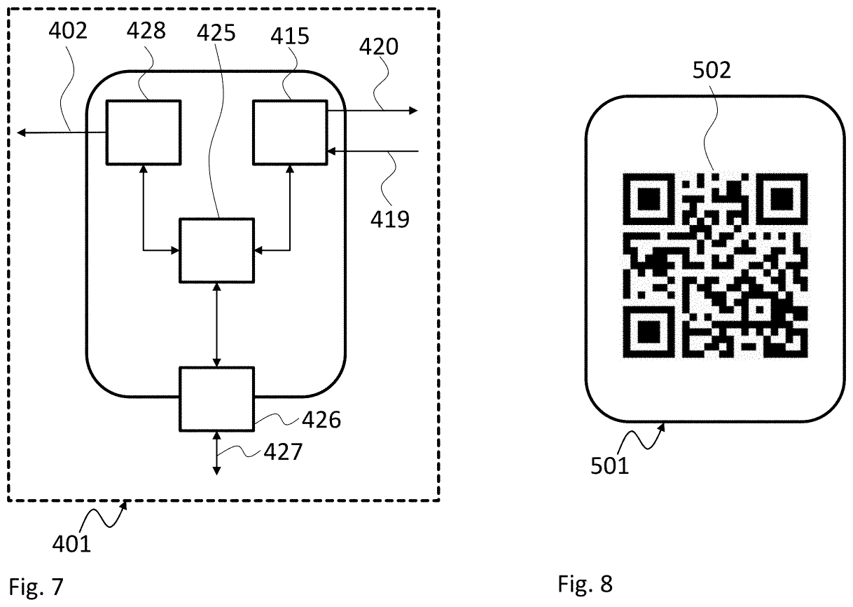

FIG. 7 shows a block diagram of a merchant terminal 401. The merchant terminal 401 comprises a merchant terminal controller 425 that is coupled to a user interface 415, to a transaction output interface 428, and to a first communication interface 426.

As explained above, the user interface 415 may e.g. comprise a display and a keyboard, a touchscreen, or any other type of user interface. The user interface 415 serves for receiving user input 419 from the user and for providing user information 420 to the user.

The transaction output interface 428 serves for outputting the transaction information 402. The transaction output interface 428 may be any type of interface that allows providing the transaction information 402 to the user terminal and/or the transaction processor. Such an interface may e.g. comprise a RFID interface, an NFC interface, a WIFI interface, a Bluetooth interface, an optical interface or the like.

The first communication interface 426 may e.g. be a network interface that allows the merchant terminal controller 425 to communicate e.g. via a data network like a local network or the internet.

During operation the merchant terminal controller 425 may for example receive user input 419 via the user interface 415 regarding an amount in a fiat currency and the cryptocurrency to be used for the transaction. The merchant terminal controller 425 may then automatically retrieve exchange information regarding the exchange rate of the cryptocurrency that is to be used for the transaction with regard to a reference fiat currency or a different cryptocurrency via the first communication interface 426. The merchant terminal controller 425 may also retrieve transaction fee information 427 regarding transaction fees for the transaction. The merchant terminal controller 425 may then e.g. calculate the total amount of coins and/or assets of the respective cryptocurrency to be paid and sum up the fees. This information, e.g. the total costs in the respective cryptocurrency, may then be provided to the user as user information 420 via the user interface 415. It is understood, that the user, i.e. the merchant, may also provide information about whether the fees should be paid by the merchant or the client.

If the user, i.e. the merchant, agrees to the transaction, the merchant terminal controller 425 generates the corresponding transaction information 402. The transaction information 402 comprises every piece of information that is required by the transaction processor to generate the transaction. The transaction information 402 for example may comprise a wallet address of a wallet of the operator of the merchant terminal 401 for the cryptocurrency that is used for the transaction. This wallet may e.g. be a wallet to which the automatic transaction handling processor has access, as will be described below. In addition, the transaction information 402 comprises the amount of coins and/or of assets in said cryptocurrency.

The merchant terminal controller 425 then outputs the transaction information 402 via the transaction output interface 428. The transaction information 402 may then be received by the client terminal, which is required to either perform the transaction or provide the required cryptographic key for performing the transaction.

In the client terminal, the client may review the transaction and initiate the transaction if he accepts the details provided with the transaction information 402.

In case the transaction is performed in the client terminal, the transaction processor is provided in the client terminal, e.g. as part of a wallet application. In case that the transaction is not provided in the client terminal, the transaction processor may e.g. be provided in the merchant terminal or as dedicated device, that may be accessible e.g. via a network connection. In this case, the client terminal may—e.g. after receiving the user's consent—provide the respective cryptographic key for performing the transaction.

It is understood, that in embodiments the user interface 415 and the transaction output interface 428 may both be the same interface, if the transaction information 402 is provided as visual code. However, it is possible that two separate displays are provided in the merchant terminal 401. A first display may be provided as the user interface 415 and a second display may be provided as the transaction output interface 428.

It is understood, that the transaction information 402 may be provided as human readable information instead of a code. This is especially useful, if the client terminal is for example a paper wallet or a mere memory or memory token without any display or user input. The user may then read the transaction information 402 and for example insert his memory card or token or provide his paper wallet to a scanner of the merchant terminal 401 if he accepts the transaction information 402.

FIG. 8 shows a block diagram of merchant terminal 501. The merchant terminal 501 of FIG. 8 comprises the transaction information as a visual code 502. The visual code 502 may e.g. be provided on a sticker or patch and may comprise the transaction information that is required to perform a transaction e.g. from a client terminal.

The transaction information embedded in the visual code 502 may for example comprise a wallet address of a wallet of the merchant, i.e. a wallet that pertains to the merchant and to which the automatic transaction handling processor has access. This wallet may be the above-mentioned system wallet.

A client may therefore scan the visual code with his client terminal. In the client terminal the client may then input the respective amount of coins and/or assets of the respective cryptocurrency and initiate a transaction.

The processing system may then e.g. inform the merchant about a transfer that is received by this address and about the amount of coins and/or assets, and optionally the respective value in a fiat currency, that have been received. This information may e.g. be passed to the merchant via another channel, e.g. via SMS, an email, a messenger message or the like.

However, as alternative, the transaction information embedded in the visual code 502 may also comprise the wallet address of a dedicated wallet of the operator of the processing system. The processing system may then e.g. automatically transfer any coins and/or assets incoming to this address as respective amount of a fiat currency to a bank account of the merchant.

As further alternative, the transaction information embedded in the visual code 502 may comprise information that may be provided as additional information in the transaction. Such additional information may e.g. be the number of a bank account of the merchant. The destination address for the transaction may in this case e.g. be the address of a wallet of the operator of the processing system. The operator may use the same wallet for multiple merchants. Any incoming transaction may then be analyzed by an element of the processing system for the additional information comprising a bank account number. Incoming coins and/or assets may then be transferred as respective amount of fiat currency to the bank account number as indicated in the additional information.

As will be shown in more detail below, the merchant terminal 501 may also comprise a display and dynamically create the visual code 502. Such a merchant terminal 501 may also comprise a network interface and e.g. retrieve a new address for every transaction or additional information for every transaction.

Using such a simple or even passive merchant terminal 501 allows any merchant to easily participate in the cryptocurrency market. Clients willing to pay with a cryptocurrency may already have a wallet application installed e.g. on their smartphone or the like and use the transaction information in the visual code 502 with the respective wallet application.

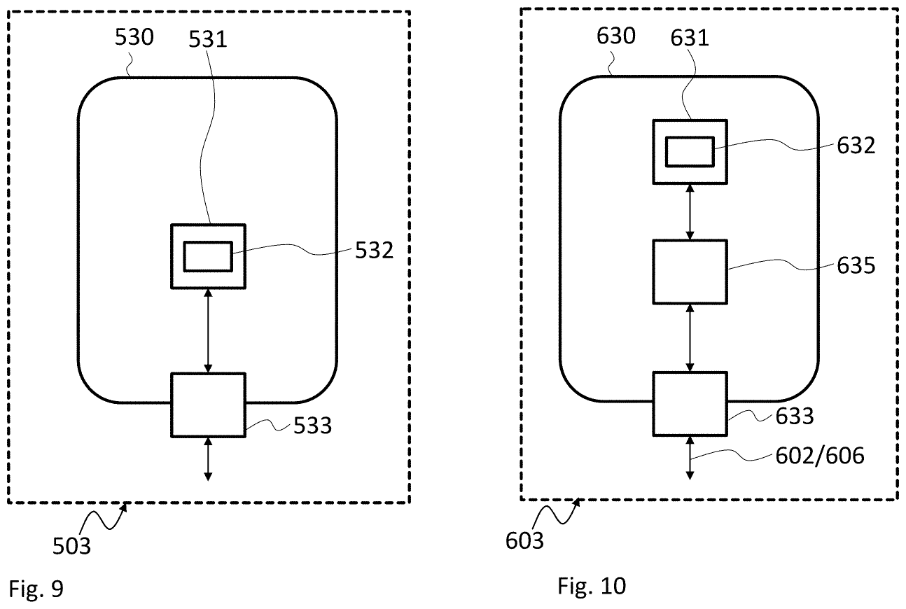

FIG. 9 shows a block diagram of a client terminal 503. The client terminal 503 comprises a memory token 530 with a memory 531 that is coupled to a communication interface 533. The memory 531 comprises at least the secret cryptographic key 532 that corresponds to a wallet or address of the client.

The memory 531 may be a tamper resistant memory with special features that prevent a malicious attacker from retrieving the secret cryptographic key 532 from the memory 531. Such a memory may e.g. comprise elements that erase the contents of the memory when an electronic or physical attack is detected. Further, the memory 531 may for example comprise encryption and decryption units for automatically encrypting and decrypting the contents of the memory 531. The key for encrypting and decrypting may e.g. be provided via the communication interface 533 or via dedicated means, like e.g. a fingerprint scanner on the memory token 530 or the like.

The communication interface 533 may be a contact-based communication interface 533, like e.g. a smartcard or memory card contact terminal. The communication interface 533 may also be a wireless interface, like e.g. a RFID or NFC interface.

FIG. 10 shows a block diagram of another client terminal 603. The client terminal 603 is based on the client terminal 503 and comprises a transaction processor 635 that is coupled to the memory 631 and to the communication interface 633. This means that the memory 631 is not directly coupled to the communication interface 633.

With the client terminal 603 the secret cryptographic key 632 is not provided from the memory 631 to the communication interface 633. Instead, the transaction processor 635 receives the information required to create the transaction, e.g. transaction information 602, creates the transaction 606 with the secret cryptographic key 632 and outputs the transaction 606 via the communication interface 633.

Using a “smart” client terminal 603, i.e. a client terminal 603 with the transaction processor 635 included, allows performing transactions without the need to transfer the secret cryptographic key 635 to another entity in the processing system.

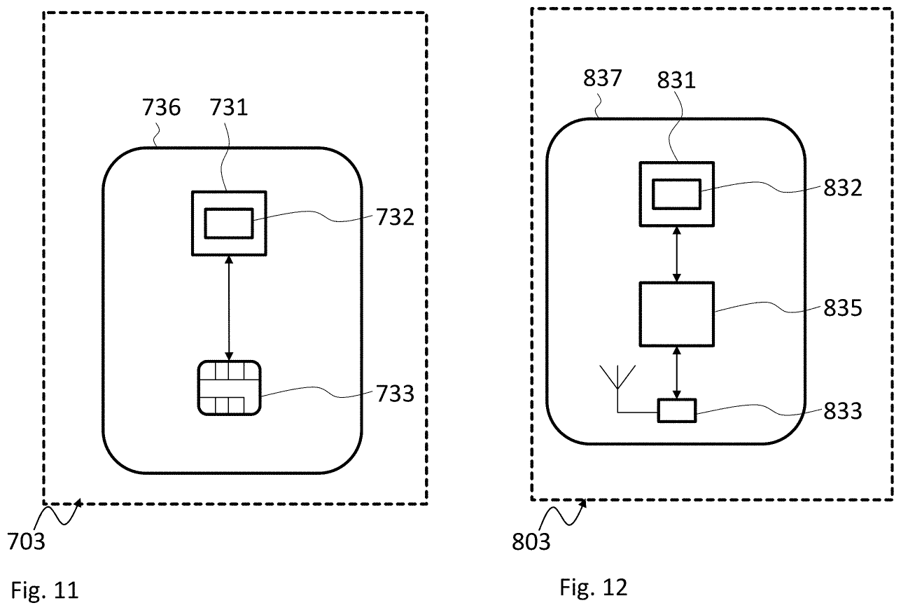

FIG. 11 shows a block diagram of another client terminal 703. The client terminal 703 is provided as a memory card 736. The memory card is a contact-based memory card and therefore comprises a contact-based communication interface 733. The communication interface 733 is coupled to a memory 731 that comprises at least the secret cryptographic key 732 and possibly also the public cryptographic key (not separately indicated) of a pair of keys for a wallet of a cryptocurrency.

The memory card 736 may be in the form of cards as used e.g. for credit cards or the like. The memory card 736 may therefore have standard size and the communication interface 733 may e.g. be a standard contact-based or contact-type interface to the memory 731 in the memory card 736.

Therefore, in a counterpart, e.g. the merchant terminal, a respective card reader or card slot may be provided. Such a card reader or card slot may comprise respective contacts, e.g. spring-loaded contacts that contact the single contacts of the communication interface 733 when the memory card 736 is inserted into the card reader.

It is understood, that the contents of the memory 731, especially the cryptographic key 732, may be encrypted. Such an encryption prevents the use of the cryptographic key 732 without the owner's consent. The encryption may e.g. be performed based on a pin, a password, a fingerprint or any other security feature, and may e.g. be performed with the AES encryption algorithm or any other adequate encryption algorithm.

It is understood, that to this end, an encryption and decryption processor may be provided in the memory card 736.

It is understood, that although a contact-based or contact-type memory card 736 is shown in FIG. 11, the client terminal 703 may also be provided as a wireless smartcard, e.g. with an NFC or RFID interface or the like.

FIG. 12 shows a block diagram of another client terminal 803. The client terminal 803 comprises a smartcard 837. In the smartcard 837 a memory 831 is provided that stores the cryptographic key 832. Further, a transaction processor 835 is coupled to the memory 831. The transaction processor 835 is further coupled to a wireless communication interface 833.

The wireless communication interface 833 may for example be a RFID or NFC interface for wirelessly communicating with the smartcard 837, e.g. via a merchant terminal.

As with the client terminal 703, the cryptographic key 832 is stored inside of the client terminal 803, in the memory 831. However, the transaction processor 835 is arranged between the memory 831 and the wireless communication interface 833. Therefore, the cryptographic key 832 is not required to be transmitted via the wireless communication interface 833. Instead, at least some of the cryptographic functions required to perform a transaction may be performed directly in the transaction processor 835.

The transaction processor 835 may for example perform signature functions or encryption functions based on the cryptographic key 832 stored in the memory 831. To this end, e.g. the merchant terminal, may provide even transaction data to the transaction processor 835 via the wireless communication interface 833. The transaction data may for example comprise the data that needs to be signed or encrypted in order to provide a valid transaction. The transaction processor 835 may then e.g. output the signature for the transaction data via the wireless communication interface 833.

In another possible embodiment, the transaction processor 835 may receive the transaction information via the wireless communication interface 833. The transaction processor 835 may then create the transaction data by itself and perform the respective cryptographic functions. In this embodiment the transaction processor 835 may for example output the transaction data and the respective signature via the wireless communication interface 833.

The output from the smartcard 837 may then e.g. be received by the merchant terminal and may be provided to the respective cryptocurrency network, where the transaction may then be processed.

It is understood, that although the client terminal 803 is described with the wireless communication interface 833, in other embodiments a wired or contact-type interface may also be provided.

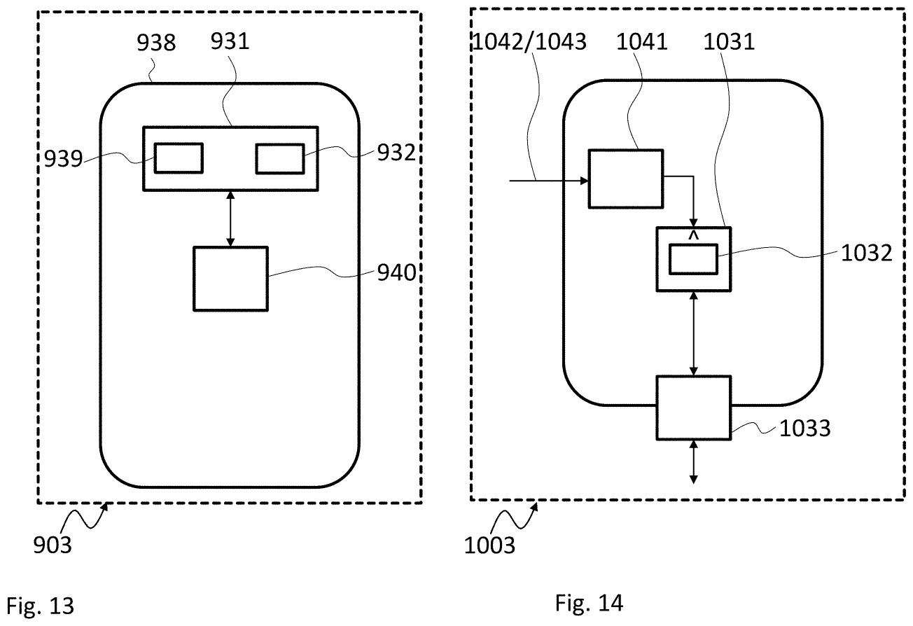

FIG. 13 shows a block diagram of another client terminal 903. The client terminal 903 comprises a smartphone 938. It is understood, that instead of a smartphone any other computing device, like e.g. a tablet PC, a notebook, a desktop computer or the like, may be provided for the client terminal 903.

The smartphone 938 comprises a memory 931 that is coupled to a processor 940. Further, the memory 931 comprises the cryptographic key 932 and an application 939.

In the client terminal 903 the function of the transaction processor may be provided by the application 939. The application 939 may therefore provide all functions that are mentioned in this document regarding the transaction processor.

It is understood, that such an application 939 may also provide additional functions, like e.g. an address or wallet management and the like. Such an application may generally be called a wallet application. It is further understood, that such an application may for example be executed by an operating system. Such an operating system may provide basic functionality to applications, like e.g. hardware access to interfaces like user interfaces, communication interfaces, or storage device like memories, hard disks and the like.

It is further understood, that the application 939 may also be a remote or web-based application. Such applications may be loaded by the operating system or another program, like e.g. a browser, into the memory 931 and may be executed after downloading. Web-based applications may especially be provided as script-based applications, e.g. a JavaScript based application and may be executed in the environment of a web-browser.

In an embodiment, the application 939 may further comprise encryption and decryption functions and the cryptographic key 932 may be stored in an encrypted format in the cryptographic key 932. As explained above any encryption algorithm may be used, like e.g. AES or the like. The security token or key, that is necessary to decrypt the encrypted cryptographic key 932 may for example be provided to the application 939 by a user via a user interface of the smartphone 938 or via a sensor, like e.g. a fingerprint sensor or a camera of the smartphone 938.

FIG. 14 shows a block diagram of another client terminal 1003. The client terminal 1003 comprises a memory 1031 that stores the cryptographic key 1032. The memory 1031 is coupled to a communication interface 1033 that allows the memory 1031 to output the cryptographic key 1032 on request. The client terminal 1003 further comprises a user interface 1041 that is coupled to the memory 1031.

The user interface 1041 is configured to receive from a user a user's consent 1042 and/or transaction information input 1043.

The user's consent 1042 may in an embodiment be required to enable the memory 1031 to provide the cryptographic key 1032 via the communication interface 1033. To allow a user to provide his consent 1042, the user interface 1041 may e.g. comprise a simple button. As alternative, the user interface 1041 may comprise a keypad for inputting a pin, a sensor like a fingerprint sensor or an iris scanner or the like. The user interface 1041 may then provide the enable signal to the memory 1031 after the user provides the required input.

It is understood, that the client terminal 1003 may comprise further elements, like e.g. a processor and that the processor may be coupled to the user interface 1041, the memory 1031 communication interface 1033, and may perform the required functions, like verifying the user's consent and then outputting the cryptographic key 1032 via the communication interface 1033. Such a processor may also perform the functions of a transaction processor.

If a processor is provided, the processor may also receive the transaction information input 1043 from the user via the user interface 1041. The processor may then create the data that is necessary for or that forms the transaction based on the transaction information input 1043 provided by the user and perform the required cryptographic functions.

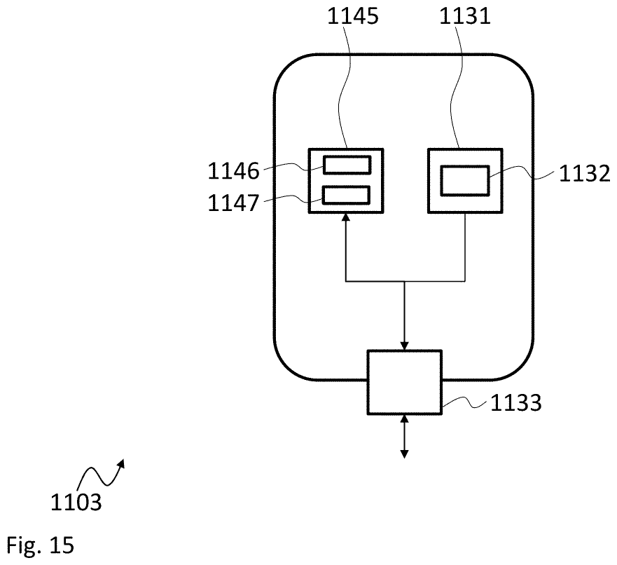

FIG. 15 shows a block diagram of another client terminal 1103. The client terminal 1103 comprises a memory 1131 that stores a cryptographic key 1132. In addition, the client terminal 1103 comprises a setting memory 1145, wherein the setting memory 1145 and the memory 1131 are both coupled to a communication interface.

The setting memory 1145 stores user settings 1146. Such user settings 1146 may refer to preferences of the client, like e.g. to a preferred cryptocurrency. The client terminal 1103 may for a transaction output at least some of the stored user settings 1146, e.g. to the merchant terminal. The merchant terminal may then perform the respective selections, e.g. of the cryptocurrency, and create respective transaction information.

As an option, the setting memory 1145 may also store automatic transaction user settings 1147. The automatic transaction user settings 1147 enable automatic and therefore quick transactions, without specific consent of the user.

However, to prevent arbitrary transactions being performed from the clients' wallets, the automatic transaction user settings 1147 may provide specific details or requirements that have to be fulfilled in order to allow an automatic transaction taking place.

For example, a user may set a maximum amount of coins or assets for one or more cryptocurrencies that he consents to be automatically transferred in a transaction. The user may also set a maximum number of transactions for a predetermined amount of time. This automatic transaction user settings 1147 therefore define how many transactions may automatically be performed in the respective amount of time. The user may also define, with which cryptocurrency or cryptocurrency automatic transactions may be performed at all. It is understood, that the user may set any combination of the above automatic transaction user settings 1147.

A client may therefore for example specify that transaction to an amount of about 10€ in one or more cryptocurrencies that he specifies may be performed once every 10 minutes or every hour or the like. Any other combination of requirements is also possible.

It is understood, that the client terminal 1103 may for example comprise a processing device coupled between the memory 1131, the setting memory 1145 and the communication interface 1133. The processor may then verify that a transaction conforms to the automatic transaction user settings 1147 and only provide the cryptographic key 1132 or sign the respective transaction data or the like if the transaction conforms to the automatic transaction user settings 1147.

It is understood, that all the above elements described in conjunction with the client terminal may be feely combined. For example, the client terminal may comprise an application being executed on a computing device like a smartphone and the application may comprise the setting memory 1145 with user settings 1146 and/or automatic transaction user settings 1147. In addition, or as alternative, such a client terminal may also comprise the user interface for acquiring the user's consent, e.g. in the form of an input field on a touchscreen of the computing device. Further, such a client terminal may comprise a wired or wireless communication interface for communication with e.g. a merchant terminal. Such communication may be a direct communication e.g. via Bluetooth or the like or an indirect communication e.g. via a WIFI access point and a data network.

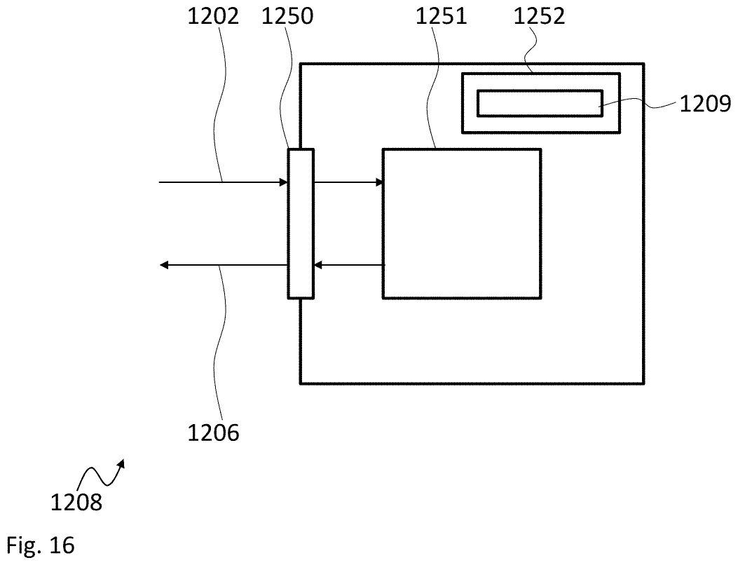

FIG. 16 shows a block diagram of an automatic transaction handling processor 1208. The automatic transaction handling processor 1208 comprises a transaction interface 1250 and a local transaction processor 1251 that is coupled to the transaction interface 1250. Further, a memory 1252 is coupled to the local transaction processor 1251. The memory 1252 comprises a predetermined transfer policy 1209 or multiple predetermined transfer policies.

The transaction interface 1250 may be a communication interface that allows the local transaction processor 1251 to communicate transaction data e.g. with a cryptocurrency network. This means for example, that the local transaction processor 1251 may receive transaction information 1202 or transaction data, i.e. in the form of the transaction of the data of the transaction or a block comprising the transaction that is communicated in the cryptocurrency network. In addition, the local transaction processor 1251 may communicate data into the cryptocurrency network or into multiple cryptocurrency networks. The local transaction processor 1251 may use the transfer policy 1209 and for example initiate respective transactions after receiving one or more transactions from a client wallet. Further, it is understood, that the local transaction processor 1251 may also communicate transaction data e.g. via a channel, like e.g. a channel of the lightning network that is being developed for the bitcoin network. The lightning network is a network that is provided parallel to the bitcoin network and provides channels for performing transactions off-line off the bitcoin network. Such channels may be considered as communication via the cryptocurrency network. At certain points in time, the balances of the channels may then be ausgeglichen via transactions in the bitcoin network.

This means, that the local transaction processor 1251 may e.g. act like a node in the cryptocurrency network that is capable of receiving data from the cryptocurrency network and capable of providing data into the cryptocurrency network. It is understood, that the local transaction processor 1251 may be a hardware unit or a computer program or a combination of both. The local transaction processor 1251 may for example be provided as an application that is executed by an operating system running on a server or e.g. as a cloud-based application.

As explained above, the local transaction processor 1251 may have access to a wallet of the merchant, that may e.g. be called the system wallet. The system wallet may for example serve to automatically redistribute and/or split incoming transactions. To this end, the local transaction processor 1251 may for example have direct access to the required cryptographic keys. Such cryptographic keys may e.g. be stored in the memory 1252 or such cryptographic keys may be stored in a wallet storage that may be provided in the processing system and will be explained in detail below. Further, instead of performing the transactions like a node of the respective cryptocurrency network, the local transaction processor 1251 may also access a service that allows performing transactions in the respective cryptocurrency network. It is understood, that such a service as well as the wallet storage may e.g. be provided as services that may be accessed with a specific API (application programming interface) via a network or on the same computer as the local transaction processor 1251.

The local transaction processor 1251 may therefore analyze or track all transactions that arrive for a merchant and may automatically perform respective redistribution or splitting transactions based on the transfer policy 1209.

The transfer policy 1209 may for example specify that every single incoming transaction is directly split and/or redistributed. As alternative the transfer policy 1209 may specify that splitting and/or redistributing is only performed after a specific amount of time has passed or after a predetermined number of transactions has been received for the respective merchant, or after a specific amount of coins and/or assets has been received by the respective merchant. Further, the transfer policy may indicate a target currency for the redistribution and/or splitting of the incoming transaction. This means that the local transaction processor 1251 may use different cryptocurrencies for splitting and/or redistributing than used for the initial transaction. To this end, the local transaction processor 1251 may be communicatively coupled to an exchange service, that allows the local transaction processor 1251 to exchange one cryptocurrency for another. The local transaction processor 1251 may e.g. receive the exchange coins, i.e. coins in the target cryptocurrency, from the exchange service to a wallet under his control and then perform the redistribution and/or splitting.

To reduce the number of required transactions and therefore the network load and e.g. transaction fees, the local transaction processor 1251 may for example indicate the final or target address to the exchange service and only transfer the respective amount of coins and/or assets to the exchange service. This will save the transaction from the exchange to the wallet under possession of the local transaction processor 1251 and the coins and/or assets will arrive more quickly at the final destination.

Splitting may then e.g. comprise transferring a part of the available coins and/or assets to a first address or wallet and transferring the remaining coins and/or assets to another address or wallet or to multiple addresses or wallets. Redistributing may comprise transferring at least a part of the available coins and/or assets of a merchant to one or multiple addresses.

A specific transfer policy may for example be provided for each of multiple merchant terminals, especially for multiple terminals operated by the same operator, or for multiple terminals operated by different operators. The transfer policy may also comprise a policy based on tracking information of the user of the client terminal and/or of the operator of the merchant terminal and/or of the merchant terminal itself. Such tracking information may e.g. be embedded as additional information in the transaction. Further, a standard transfer policy may be used for transactions if no specific transfer policy applies to the transaction.

It is understood, that the transfer policy not necessarily needs to be stored in the local transaction processor 1251. The transfer policy may also be provided at least in part by the merchant terminal and/or the client terminal to the automatic transaction handling processor 1208, e.g. via the transaction interface 1250.

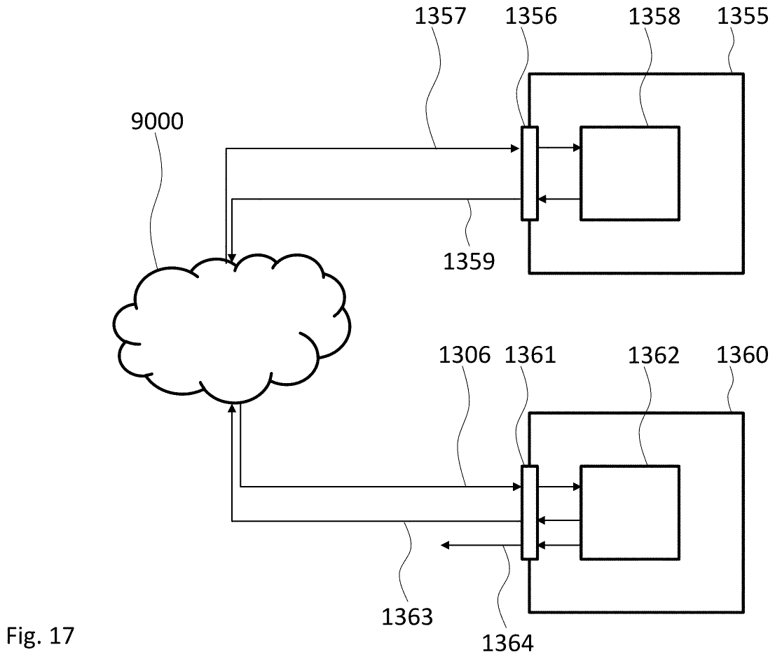

FIG. 17 shows a block diagram of an exchange rate service 1355 and an exchange service 1360. It is understood, that although shown in a single figure, the exchange service 1360 and the exchange rate service 1355 may also be provided as single entities.

The exchange rate service 1355 comprises a communication interface 1356 and an exchange rate memory 1358. The exchange rate service 1355 is coupled to a network, e.g. the internet, via the communication interface 1356. The exchange rate service 1355 may therefore receive rate requests 1357 via the network. The exchange rate service 1355 may then look up the respective exchange rates 1359, that may e.g. be stored in the form of a table, from the exchange rate memory 1358 and provide the exchange rates 1359 to the source of the request, e.g. to a merchant terminal, or a client terminal, or an automatic transaction handling processor. In the exchange rate memory 1358 the exchange rates 1359 may be stored for different pairings of cryptocurrencies and/or cryptocurrencies and fiat currencies. In addition, the exchange rates 1359 may be stored for different exchange services 1360.

It is understood, that the exchange rate service 1355 may comprise additional elements, like e.g. an updating unit or processor that may update the exchange rates 1359 stored in the exchange rate memory 1358. The updating unit or processor may for example contact one or more exchanges via the network and retrieve the required exchange rates and store the requested exchange rates in the exchange rate memory 1358.

The exchange service 1360 comprises a communication interface 1361 and an exchange processor 1362 that is coupled to the communication interface 1361. The communication interface 1361 is externally coupled to the network in order to receive transactions and/or exchange requests, and in order to send transactions into the network.

The exchange processor 1362 performs exchanges between different cryptocurrencies and or between cryptocurrencies and fiat currencies, as requested e.g. via transactions 1306 or via exchange requests that arrive at the exchange service 1360.

If a transaction 1306 is used to request an exchange, this request may be specified in more detail in additional information that may be stored with the transaction. Such additional information may for example comprise a target currency, a user identification, a target address and/or a bank account number.

If for example the target currency comprises a cryptocurrency and a target address is given, the exchange processor 1362 may generate a respective transaction in the target currency to the target address with the respective amount of coins and/or assets. If no target address is given but a user identification is given, the exchange service may have the target address (and other user specific details) stored in a memory and retrieve the target address from the memory based on the user identification.

If the target currency is a fiat currency and a bank account number is provided in the additional data, the exchange processor 1362 may transfer a respective amount of the target currency to the target bank account. If no target bank account number is given but a user identification is given, the exchange service may have the bank account number (and other user specific details) stored in a memory and retrieve the bank account number from the memory based on the user identification.

It is understood, that the exchange rate service 1355 and the exchange service 1360 may both be provided as dedicated devices, e.g. servers. However, as alternative, the exchange rate service 1355 and the exchange service 1360 may be provided as computer program components, that may e.g. be services like web-services and provide a respective API for accessing their functions.

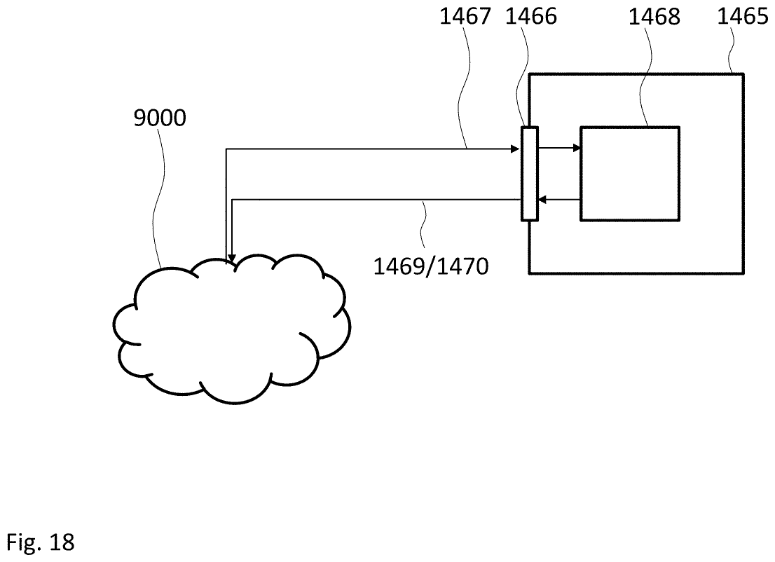

FIG. 18 shows a block diagram of an exchange rate optimizer 1465. The exchange rate optimizer 1465 serves for finding the optimum exchange rate or the optimum exchange 1469 to be used for a transaction. It is to be understood, that the optimum exchange rate or optimum exchange 1469 may not necessarily refer to the exchange with the lowest transaction fees or best exchange rate. Instead, the optimum exchange rate or exchange 1469 may also be selected based e.g. on an estimated duration for the transaction, i.e. the current load of the exchange.

The exchange rate optimizer 1465 comprises a communication interface 1466 and an optimization processor 1468 that is coupled to the communication interface 1466. Via the communication interface 1466 the optimization processor 1468 may receive optimization requests 1467, e.g. from a merchant terminal, from a client terminal or from an automatic transaction handling processor.

The optimization processor 1468 may for example store and/or request via an exchange rate service exchange rates for a plurality of possible exchanges between cryptocurrencies and between cryptocurrencies and fiat currencies.

An optimization request 1467 may comprise a source and a target currency (crypto or fiat currencies). The optimization processor 1468 may then perform the solving of an optimization problem that may be formulated as finding the best exchange (e.g. the cheapest with regard to fees, or the most balanced with regard to fees, speed, reliability, security, juridical requirements, availability in respective countries, etc.) or exchange route.

The optimum exchange 1469 or exchange route 1470 is then provided by the optimization processor 1468 as response to the optimization requests 1467.

It is understood, that the exchange rate optimizer 1465 may be provided as dedicated device, e.g. a server. However, as alternative, the exchange rate optimizer 1465 may be provided as computer program component, that may e.g. be a service like a web-service and may provide a respective API for accessing the respective functions.

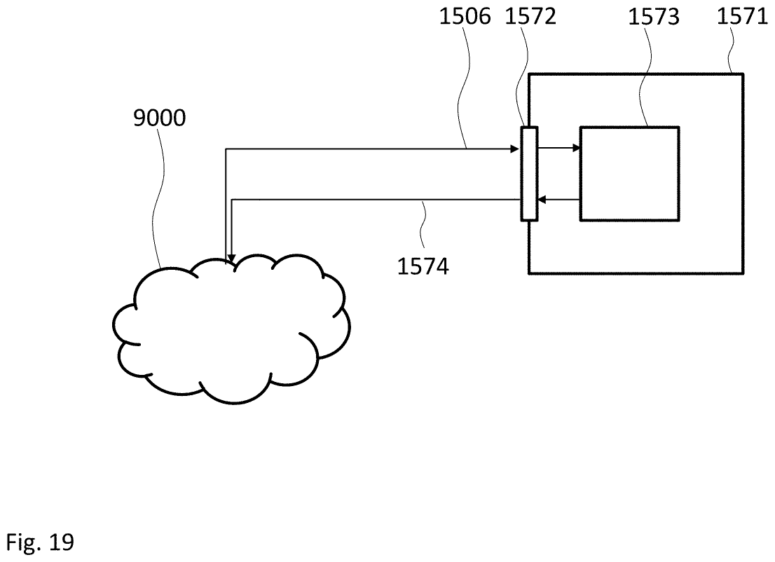

FIG. 19 shows a block diagram of a transaction verification controller 1571. The transaction verification controller 1571 comprises a communication interface 1572 and a monitor 1573 that is coupled to the communication interface 1572. The communication interface 1572 is coupled to the network.

The transaction verification controller 1571 serves for monitoring the status of a transaction 1506. The status of a transaction 1506 may refer to whether the transaction 1506 is received in the cryptocurrency network, whether the transaction is included in a block of the respective blockchain or if a predetermined number of transactions have been created after the block that contains the transaction 1506.

The monitor 1573 may be any device or unit that has access to the respective cryptocurrency network and may retrieve open transactions and created blocks from the cryptocurrency network. Therefore, the monitor 1573 may e.g. implement the communication interface or communication functions of a node of the respective cryptocurrency network. Further, the monitor 1573 may implement a parser or analyzer function that verifies if specific criteria are fulfilled, like e.g. the transaction being present in the cryptocurrency network, the transaction being included in a block of the respective blockchain, and the number of blocks being created after the blocks containing the transaction.

The monitor 1573 may e.g. report a transaction 1506 as received or pending, if it is received in the cryptocurrency network but not included in a block. The monitor 1573 may report the transaction 1506 as processed if the transaction 1506 is included in a block. The monitor 1573 may report a transaction 1506 as received or finished, if a predetermined number of blocks, e.g. 5, have been created in the blockchain after the block containing the transaction 1506. It is understood, that the measure 1574 may e.g. be a numerical measure 1574, e.g. comprising 0 for not received, 1 for received, 2 for processed, 3 for finished. It is understood, that the measure 1574 may for example also comprise a value between 0 and 100, the chances of success of the transaction 1506, a risk of failure of the transaction 1506, an estimate of the time for finalization of the transaction, possible other risks or the like.

It is understood, that the transaction verification controller 1571 may be provided as dedicated device, e.g. a server. However, as alternative, the transaction verification controller 1571 may be provided as computer program component, that may e.g. be a service like a web-service and may provide a respective API for accessing the respective functions.

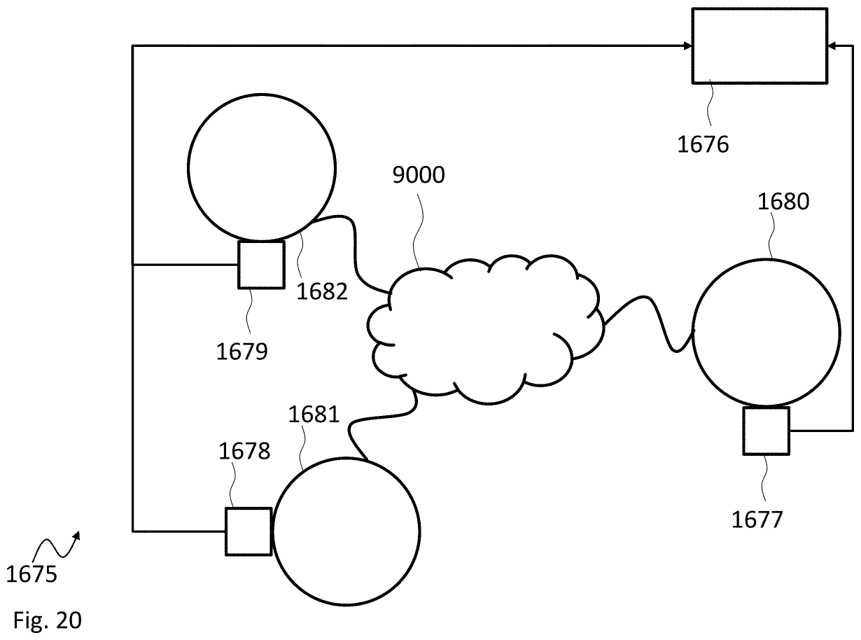

FIG. 20 shows a block diagram of a fork detection system 1675. The fork detection system 1675 may e.g. be coupled to the transaction verification controller 1571 and provide the transaction verification controller 1571 with an indication of whether a fork is present in a blockchain or not. This may allow the transaction verification controller 1571 to dynamically adapt the number of blocks necessary to accept a transaction 1506 as finished.

The fork detection system 1675 serves for monitoring a blockchain for the occurrence of a fork. Miners of a blockchain will usually be provided at spots, i.e. in countries, with low energy costs. Therefore, the miners of a cryptocurrency network will usually be located in specific spots or locations. Such locations are shown as miner locations 1680, 1681, 1682. The miner locations 1680, 1681, 1682 are coupled to the network, e.g. the internet. It is understood, that although shown as circles, the miner locations 1680, 1681, 1682 may refer to a region like a country or any geographically limited region where the number of miners is relatively high compared to the mean density of miners over the globe or over the network. It is understood, that the term region may also refer to a network region, i.e. to nodes in a network that are interconnected by connections faster than other regions in the network. In terms of the network, a region may for example comprise miners in Europe, Asia and America which are interconnected by very fast communication links.

To identify a fork in a blockchain, the fork detection system 1675 comprises three nodes 1677, 1678, 1679 which are coupled to a central server 1676, where each of the nodes 1677, 1678, 1679 is provided at one of the miner locations 1680, 1681, 1682.

The nodes 1677, 1678, 1679 will therefore quickly receive any new blocks that are created in the respective miner locations 1680, 1681, 1682. Every one of the nodes 1677, 1678, 1679 then forwards any new blocks to the central server 1676. The central server 1676 then compares the received blocks and provides a fork warning if two blocks of the same block number comprise different content.

If for example in miner location 1680 and miner location 1681 a block 100 is created at approximately the same time with different content, the node 1677 will first receive the block 100 from miner location 1680, and node 1678 will first receive the block 100 from miner location 1681.

The central server 1676 will receive both blocks and detect the differences. Consequently, the central server 1676 will provide a fork warning.

It is understood, that the function of the central server 1676 may also be implemented in one of the nodes 1677, 1678, 1679.

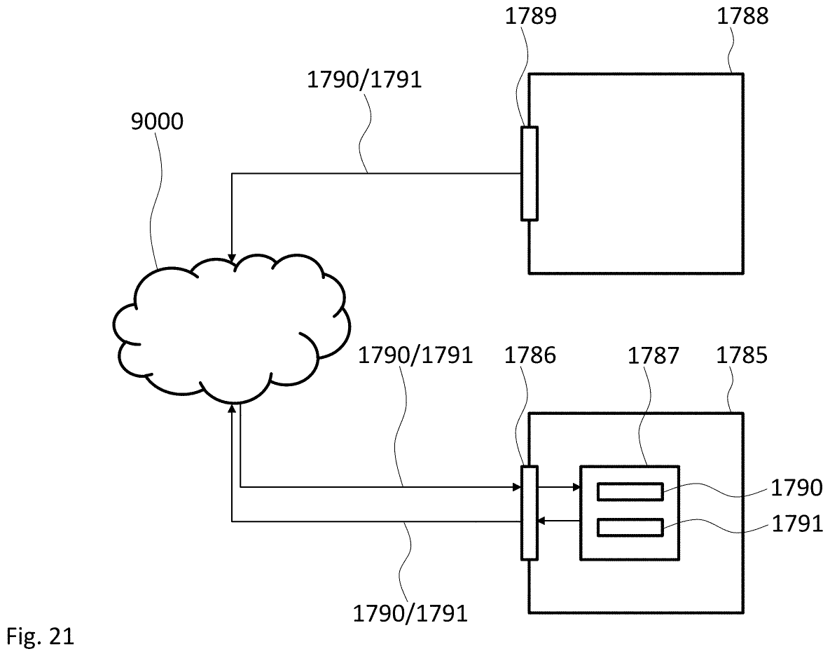

FIG. 21 shows a block diagram of a wallet storage 1785 and a wallet generator 1788. It is understood, that although shown in the same figure, the wallet storage 1785 and the wallet generator 1788 may be provided independently of each other.

The wallet storage 1785 may comprise a simple memory 1787 that may store wallets, like e.g. the system wallet and the storage wallet of a merchant. It is understood, that the term “storing” with reference to a wallet refers to storing the respective cryptographic keys, especially the secret cryptographic key, addresses, settings and any other relevant data, like metadata about the users and/or the wallets. It is further understood, that the wallet storage 1785 may also comprise a local database or a remote database, e.g. as a service of the processing system.

The wallet storage 1785 may in an embodiment store the respective keys in encrypted form and may comprise an encryption and/or decryption unit that performs the encryption and decryption of the cryptographic keys.

Although not shown, an authentication mechanism may be implemented in the wallet storage 1785 and/or the wallet generator 1788 or may be provided as a service via the network. The wallet storage 1785 and/or the wallet generator 1788 may then only provide data to or exchange data with authenticated peers.

Therefore, for example the automatic transaction handling processor may request from a merchant the respective authentication credentials and may then request the respective cryptographic keys from the wallet storage 1785 to perform respective transactions. The automatic transaction handling processor may also store the cryptographic keys to the system wallets in the wallet storage 1785 and may request these as required to perform the splitting and/or redistribution of coins and/or assets.

In the processing system the initial creation of the wallets, e.g. the system wallet and the merchant wallet of a new merchant, may e.g. be performed manually by the respective merchant. However, as alternative, the wallet generator 1788 may generate the respective wallets automatically on request. It is understood, that a single wallet, i.e. a pair of a public and a private cryptographic key may in some cases be used only once. Therefore, the wallet generator 1788 may generate new cryptographic keys as required during the operation of the processing system. Merchant terminals or client terminals may for example request new wallets, addresses or cryptographic keys for every transaction.

It is understood, that the merchant terminals, client terminals and the automatic transaction handling processor may also authenticate with the wallet generator 1788 as explained above for the wallet storage 1785.

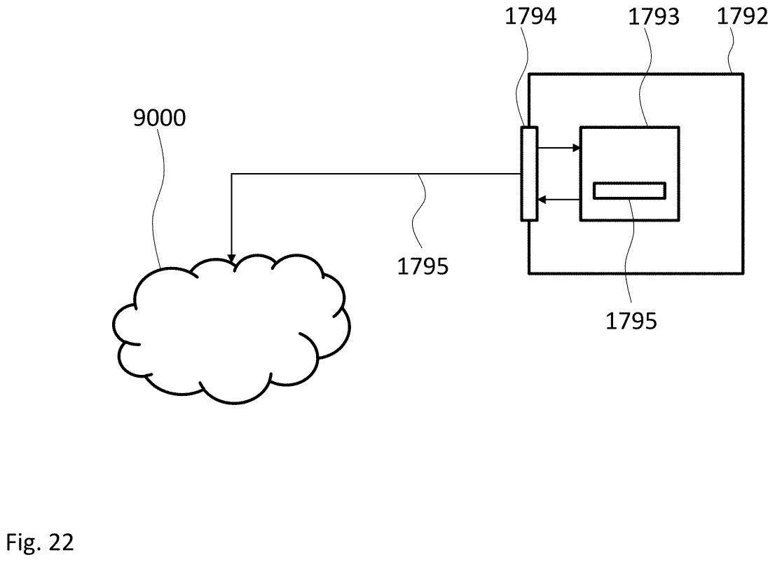

FIG. 22 shows a block diagram of a directive verification processor 1792. The directive verification processor 1792 may comprise at least one private key 1795 of the two private keys to which the processing system has access for the system wallet, if the system wallet is provided as a 2-of-4 wallet. This means, that the other private key may be stored e.g. in the above-mentioned wallet storage. As alternative, both private keys to the system wallet may be stored in the directive verification processor 1792. It is understood, that the explanations regarding the directive verification processor 1792 may also be applied to the storage wallet.

The directive verification processor 1792 verifies if a transaction conforms to predetermined directives or policies as mentioned above prior to releasing the private key 1795 for performing the respective transaction.

With the directive verification processor 1792 it can therefore be made sure, that no arbitrary transactions are performed but that only those transactions that conform to the directives are performed e.g. from the system wallet.

The directives may e.g. comprise a receiving address to which the transaction has to be destined, a maximum amount of coins and/or assets, a specific cryptocurrency, and the like.

It is understood, that the directive verification processor 1792 may be provided as dedicated device, e.g. a server. However, as alternative, the directive verification processor 1792 may be provided as computer program component, that may e.g. be a service like a web-service and may provide a respective API for accessing the respective functions. Further, the directive verification processor 1792 may be communicatively coupled to an authentication service and only serve authenticated users.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

The present disclosure provides a processing system 100 for processing a number of cryptocurrencies, the processing system 100 comprising a merchant terminal 101, 201, 301, 401, 501 configured to generate transaction information 102, 402, 502, 602, 802, 1202, a client terminal 103, 503, 603, 703, 803, 903, 1003, 1103 1903 configured to provide a cryptographic key 104532, 632, 732, 832, 932, 1032, 1132, required for performing a transaction 106, 606, 806, 1206, 1306; 1506 based on the generated transaction information 102, 402, 502, 602, 802, 1202, a transaction processor 105635, 835 configured to provide the transaction 106, 606, 806, 1206, 1306; 1506 as indicated by the transaction information 102, 402, 502, 602, 802, 1202 based on the cryptographic key 104532, 632, 732, 832, 932, 1032, 1132, provided by the client terminal 103, 503, 603, 703, 803, 903, 1003, 1103 1903, and an automatic transaction handling processor 108, 1208, configured to process transactions 106, 606, 806, 1206, 1306; 1506 generated by the client terminal 103, 503, 603, 703, 803, 903, 1003, 1103 1903 and to automatically split and/or redistribute transferred funds based on a predetermined transfer policy 109.

List of reference signs

| | |
|---|---|
| 100 | processing system |
| 101, 201, 301, 401, 501 | merchant terminal |
| 102, 402, 502, 602, 802, 1202 | transaction information |
| 103, 503, 603, 703, 803, 903, 1003 | client terminal |
| 1103 | client terminal |
| 104, | cryptographic key |
| 105, | transaction processor |
| 106, 606, 806, 1206, 1306; 1506 | transaction |
| 107 | cryptocurrency network |
| 108, 1208, | automatic transaction |
| | handling processor |
| 109, 1209, | predetermined transfer policy |
| 110, 111 | outgoing transactions |
| 215, 315, 415 | user interface |
| 216, 316 | keyboard |
| 217 | display |
| 218 | user |
| 219, 419 | user input |
| 220, 420 | user information |
| 425 | merchant terminal controller |
| 426 | first communication interface |
| 427 | status, exchange and/or |
| | transaction fee information |
| 428 | transaction output interface |
| 530, 630 | memory token |
| 531, 631, 731, 831, 931, 1031, 1131 | memory |
| 532, 632, 732, 832, 932, 1032, 1132 | secret cryptographic key |
| 533, 633, 733, 833, 1033, 1133 | communication interface |
| 635, 835 | transaction processor |
| 736 | memory card |
| 837 | smartcard |
| 938 | smartphone |
| 939 | application |
| 940 | processor |
| 1041 | user interface |
| 1042 | user's consent |
| 1043 | transaction information input |
| 1145 | setting memory |
| 1146 | user settings |
| 1147 | automatic transaction user settings |
| 1250 | transaction interface |
| 1251 | local transaction processor |
| 1252 | memory |
| 1355 | exchange rate service |
| 1356 | communication interface |
| 1357 | rate request |
| 1358 | exchange rate memory |
| 1359 | exchange rates |
| 1360 | exchange service |
| 1361 | communication interface |
| 1362 | exchange processor |
| 1363 | cryptocurrency |
| 1364 | fiat currency |
| 1465 | exchange rate optimizer |
| 1466 | communication interface |
| 1467 | optimization request |
| 1468 | optimization processor |
| 1469 | optimum exchange |
| 1470 | exchange route |
| 1571 | transaction verification controller |
| 1572 | communication interface |
| 1573 | monitor |
| 1574 | measure |
| 1675 | fork detection system |
| 1676 | central server |
| 1677, 1678, 1679 | node |
| 1680, 1681, 1682 | miner location |
| 1785 | wallet storage |
| 1786 | communication interface |
| 1787 | memory |
| 1788 | wallet generator |
| 1789 | communication interface |
| 1790 | system wallet |
| 1791 | storage wallet |
| 1792 | directive verification processor |
| 1793 | memory |
| 1794 | communication interface |
| 1795 | private key |
| S1, S2, S3, S4 | method steps |
| S11, S12, S13, S14 | method steps |
| S21, S22, S23, S24 | method steps |
| S31, S32, S33, S34 | method steps |

1. Processing system for processing a number of cryptocurrencies, the processing system comprising:
a merchant terminal configured to generate transaction information as a basis for the generation of transactions with one of the cryptocurrencies, and
an automatic transaction handling processor configured to process transactions generated based on the transaction information and to at least one of automatically split or redistribute at least one of transferred coins or assets based on a predetermined transfer policy.

2. The processing system according to claim 1, comprising:
a client terminal configured to provide a cryptographic key required for performing the transaction based on the generated transaction information, and
a transaction processor configured to perform the transaction of at least one of coins or assets of the respective one of the cryptocurrencies as indicated by the transaction information based on the cryptographic key provided by the client terminal, wherein the automatic transaction handling processor is especially configured to process transactions generated by the transaction processor.

3. The processing system according to claim 1, wherein the merchant terminal comprises a user interface configured to receive user input and to output respective user information, wherein the user input refers to an amount of at least one of a fiat currency or to an amount of at least one of coins or assets of the cryptocurrency that is to be used for the transaction or additional information.

4. The processing system according to claim 1, wherein at least one of (i) the transaction information comprises a wallet address of a wallet of the operator of the merchant terminal for a cryptocurrency that is used for the transaction and especially to which the automatic transaction handling processor has access or (ii) the transaction information comprises an amount of at least one of coins or of assets in said cryptocurrency.

5. The processing system according to claim 2, wherein the client terminal comprises a memory, the memory storing at least a secret cryptographic key for a client wallet of the cryptocurrency that is to be used for the transaction.

6. The processing system according to claim 2, wherein the client terminal comprises a setting memory configured to store user settings, and wherein the client terminal is configured to provide at least some of the stored user settings to the merchant terminal,
wherein the setting memory is configured to store automatic transaction user settings, and wherein the client terminal is configured to at least one of provide the automatic transaction user settings to the merchant terminal or to verify whether requirements defined by the automatic transaction user settings are fulfilled by the transaction.

7. The processing system according to claim 1, wherein at least one of:
(i) the predetermined transfer policy specifies how new transactions are automatically generated by the automatic transaction handling processor based on the incoming transaction performed by the transaction processor,
(ii) a specific transfer policy is provided for each of multiple merchant terminals for multiple terminals operated by the same operator,
(iii) in each case a specific transfer policy is provided for different times or time ranges,
(iv) a standard transfer policy is used for the transaction if no specific transfer policy applies to the transaction; or
(v) the predetermined transfer policy indicates a target currency for at least one of the redistribution or the splitting of the incoming transaction.

8. (canceled)

9. (canceled)

10. The processing system according to claim 1, comprising a wallet generator, that is configured to generate for the operator of the merchant terminal a system wallet and a storage wallet,
wherein at least one of:
(i) tithe system wallet is provided as at least one of a multi-signature wallet or as a hierarchical deterministic wallet, or
(ii) the storage wallet is provided as at least one of a multi-signature wallet or as a hierarchical deterministic wallet, and
wherein the processing system further comprises a wallet storage, that is configured to store for the operator of the merchant terminal the system wallet and the storage wallet.

11. The processing system according to claim 10, comprising at least one of:
(i) directive verification processor, that comprises at least one of one private key of two private keys for the system wallet, to which the processing system has access, or one private key of a single key for the storage wallet, to which the processing system has access, and that is configured to verify if a transaction conforms to predetermined directives prior to releasing the one private key for performing a transaction,
(ii) comprising an offline paper wallet generator, wherein the offline paper wallet generator is configured to print out optical codes on a piece of paper for a wallet or address that comprises a predetermined amount of at least one of coins or assets, or
(iii) comprising a contract generator configured to automatically create smart contracts based on an address provided by the user of the client terminal and the transaction information.

12. (canceled)

13. (canceled)

14. A method for processing a number of cryptocurrencies, the method comprising:
generating transaction information on a merchant side as a basis for the generation of transactions with one of the cryptocurrencies, and
processing, on a server side, the transactions generated based on the transaction information and
at least one of automatically splitting or redistributing at least one of transferred coins or assets based on a predetermined transfer policy.

15. The method of claim 14, the method further comprising:
providing a cryptographic key required for performing the transaction based on the generated transaction information on the client side, and
performing the transaction of at least one of coins or assets of one of the cryptocurrencies as indicated by the transaction information based on the cryptographic key provided on the client side.
